(19) United States
(12) Patent Application Publication
(10) Pub. No.: US 2014/0129313 A1
(43) Pub. Date: May 8, 2014

(54) SYSTEMS AND METHODS TO FACILITATE AN OFFER CAMPAIGN BASED ON TRANSACTIONS WITH DIFFERENT MERCHANTS

(71) Applicant: Visa International Service Association, San Francisco, CA (US)

(72) Inventors: Douglas Joseph Rappoport, San Mateo, CA (US); Melinda Langdon Kirkpatrick, Menlo Park, CA (US); Wesley Kimathi Marangu, Burlingame, CA (US); Heather Janette Combs, San Francisco, CA (US)

(73) Assignee: Visa International Service Association, San Francisco, CA (US)

(21) Appl. No.: 14/072,674

(22) Filed: Nov. 5, 2013

Related U.S. Application Data
(60) Provisional application No. 61/722,645, filed on Nov. 5, 2012.

(51) Int. Cl. G06Q 30/02

(52) U.S. Cl. CPC G06Q 30/0224
USPC 705/14.25

(57) ABSTRACT

Systems and methods configured to allow an offer campaign to be specified based on event requirements associated with multiple, different merchants. The event requirements are linked via prerequisite conditions to form the offer campaign. Each event may identify an event related to one merchant (e.g., a payment transaction for a purchase from the merchant) and an optional action to be performed in response to a user satisfying the requirements of the event. Each merchant in the offer campaign is allowed to insert an event related to the merchant, subsequently edit the inserted event, and identify other events in the offer campaign as prerequisite requirements of the event related to the merchant. Merchants may be prevented from inserting or editing events specific to other merchants.

### RELATED APPLICATIONS

The present application claims priority to Prov. U.S. Pat. App. Ser. No. 61/722,645, filed Nov. 5, 2012 and entitled “Systems and Methods to Facilitate an Offer Campaign based on Transactions with Different Merchants,” the entire disclosure of which is hereby incorporated herein by reference.

The present application relates to U.S. patent application Ser. No. 13/237,457, filed Sep. 20, 2011, published as 2012-0078697, and entitled “Systems and Methods to Program Operations for Interaction with Users,” U.S. patent application Ser. No. 13/237,467, filed Sep. 20, 2011, published as 2012-0072997, and entitled “Systems and Methods to Modify Interaction Rules during Run Time,” U.S. patent application Ser. No. 13/225,185, filed Sep. 2, 2011, published as 2012-0066064, and entitled “Systems and Methods to Provide Real-Time Offers via a Cooperative Database,” the disclosures of which applications are hereby incorporated herein by reference.

### FIELD OF THE TECHNOLOGY

At least some embodiments of the present disclosure relate to programming operations to be performed by computing apparatuses in general, and more particularly, but not limited to, programming operations, such as information delivery and processing, based on the processing of transaction data, such as records of payments made via credit cards, debit cards, prepaid cards, etc.

### BACKGROUND

Millions of transactions occur daily through the use of payment cards, such as credit cards, debit cards, prepaid cards, etc. Corresponding records of the transactions are recorded in databases for settlement and financial record keeping (e.g., to meet the requirements of government regulations). Such data can be mined and analyzed for trends, statistics, and other analyses. Sometimes such data are mined for specific advertising goals, such as to provide targeted offers to account holders, as described in PCT Pub. No. WO 2008/067543 A2, published on Jun. 5, 2008 and entitled “Techniques for Targeted Offers.”

U.S. Pat. App. Pub. No. 2009/0216579, published on Aug. 27, 2009 and entitled “Tracking Online Advertising using Payment Services,” discloses a system in which a payment service identifies the activity of a user using a payment card as corresponding with an offer associated with an online advertisement presented to the user.

U.S. Pat. No. 6,298,330, issued on Oct. 2, 2001 and entitled “Communicating with a Computer Based on the Offline Purchase History of a Particular Consumer,” discloses a system in which a targeted advertisement is delivered to a computer in response to receiving an identifier, such as a cookie, corresponding to the computer.

U.S. Pat. No. 7,035,855, issued on Apr. 25, 2006 and entitled “Process and System for Integrating Information from Disparate Databases for Purposes of Predicting Consumer Behavior,” discloses a system in which consumer transactional information is used for predicting consumer behavior.

U.S. Pat. No. 6,505,168, issued on Jan. 7, 2003 and entitled “System and Method for Gathering and Standardizing Customer Purchase Information for Target Marketing,” discloses a system in which categories and sub-categories are used to organize purchasing information by credit cards, debit cards, checks and the like. The customer purchase information is used to generate customer preference information for making targeted offers.

U.S. Pat. No. 7,444,658, issued on Oct. 28, 2008 and entitled “Method and System to Perform Content Targeting,” discloses a system in which advertisements are selected to be sent to users based on a user classification performed using credit card purchasing data.

U.S. Pat. App. Pub. No. 2005/0055275, published on Mar. 10, 2005 and entitled “System and Method for Analyzing Marketing Efforts,” discloses a system that evaluates the cause and effect of advertising and marketing programs using card transaction data.

U.S. Pat. App. Pub. No. 2008/0217397, published on Sep. 11, 2008 and entitled “Real-Time Awards Determinations,” discloses a system for facilitating transactions with real-time awards determinations for a cardholder, in which the award may be provided to the cardholder as a credit on the cardholder's statement.

The disclosures of the above discussed patent documents are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 illustrates a system to provide services based on transaction data according to one embodiment.

FIG. 2 illustrates the generation of an aggregated spending profile according to one embodiment.

FIG. 3 shows a method to generate an aggregated spending profile according to one embodiment.

FIG. 4 shows a system to provide information based on transaction data according to one embodiment.

FIG. 5 illustrates a transaction terminal according to one embodiment.

FIG. 6 illustrates an account identifying device according to one embodiment.

FIG. 7 illustrates a data processing system according to one embodiment.

FIG. 8 shows the structure of account data for providing loyalty programs according to one embodiment.

FIG. 9 shows a system to provide real-time messages according to one embodiment.

FIG. 10 shows a method to provide real-time messages according to one embodiment.

FIG. 11 shows a structure to specify offer rules according to one embodiment.

FIG. 12 shows a structure to specify an event according to one embodiment.

FIGS. 13-15 illustrate examples to link events according to some embodiments.

FIG. 16 illustrates a tracked position of a user in accordance with a set of offer rules according to one embodiment.

FIGS. 17-21 illustrate examples of modifying an offer rule according to some embodiments.

FIG. 22 shows a method to formulate and process offer rules according to one embodiment.

FIG. 23 shows a method to modify offer rules according to one embodiment.

FIG. 24 shows a system to process offer rules in response to transactions in a plurality of accounts of a user according to one embodiment.

FIG. 25 shows a method to process offer rules in response to transactions in a plurality of accounts of a user according to one embodiment.

FIG. 26 shows a system to provide an offer to users via different media channels according to one embodiment.

FIG. 27 shows a method to provide an offer to users through different media channels according to one embodiment.

FIG. 28 shows a method to facilitate an offer campaign according to one embodiment.

FIG. 29 shows a system to facilitate an offer campaign according to one embodiment.

### DETAILED DESCRIPTION

### Introduction

The transaction data, such as records of transactions made via credit accounts, debit accounts, prepaid accounts, bank accounts, stored value accounts and the like, can be further processed to optionally provide information for various services, such as reporting, benchmarking, advertising, content or offer selection, customization, personalization, prioritization, etc. In one embodiment of improving privacy protections, users are required to enroll in a service program and provide consent to allow the system to use related transaction data and/or other data for the related services, and the system is configured to provide the services while protecting the privacy of the users in accordance with the enrollment agreement and user consent.

For example, based on the transaction data, an advertising network in one embodiment is provided to present personalized or targeted advertisements/offers on behalf of advertisers. A computing apparatus of, or associated with, the transaction handler uses the transaction data and/or other data, such as account data, merchant data, search data, social networking data, web data, etc., to develop intelligence information about individual customers, or certain types or groups of customers. The intelligence information can be used to select, identify, generate, adjust, prioritize, and/or personalize advertisements/offers to the customers. The transaction handler may be further automated to process the advertisement fees charged to the advertisers, using the accounts of the advertisers, in response to the advertising activities.

For example, the computing apparatus can be configured to generate trigger records for a transaction handler to identify authorization requests that satisfy the conditions specified in the trigger records, identify communication references of the users associated with the identified authorization requests, and use the communication references to target real-time messages at the users in parallel with the transaction handler providing responses to the respective authorization requests. Details in one embodiment regarding the generation and delivery of messages in real-time with the processing of transactions are provided in the section entitled “REAL-TIME MESSAGES.”

For example, the computing apparatus can be programmable for real-time interaction with users to provide messages and/or offers, validate fulfillment conditions, and provide benefits to qualified users to fulfill the offers. In one embodiment, the computing apparatus is configured to be programmed via accepting definitions of independent events and linking the events via prerequisite requirements to specify qualification conditions. The linked events form a flow or network of events; and user progress in the flow or network of events is tracked. The operations for each event are performed in an atomic way to allow the user positions in the flow or network of events to be identified as being in between adjacent events in the network. As a result, the programming of the real-time interaction, including the offer rules and messages, can be easily modified during the execution of the programming. Details in one embodiment regarding the formulation and management of real-time interaction are provided in the section entitled “RULE FORMATION AND MANAGEMENT.”

For example, the computing apparatus can be configured to allow a user to use any of a plurality of registered accounts to participate in an offer campaign, such as performing transactions in the registered accounts to fulfill requirements to obtain the benefit of the offer campaign. In one embodiment, the offer campaign is programmed by offer rules that identify the real time interactions with the user in response to the actions of the user, such as transactions made using any of the registered accounts of the user. The offer campaign for the user is driven at least in part by the actions of the user, such as the transactions made by the user. In one embodiment, transactions in the registered accounts of the user jointly advances the offer campaign for the user; and a milestone achieved in the offer campaign using one account of the user is recognized as a milestone achieved by the user with respect to the multiple registered accounts. Thus, the offer campaign for the user can be advanced by the user via different accounts, as if the registered accounts were a same account; and the user is not limited to using a particular account to participate in the offer campaign, nor using different accounts to drive the offer campaign separately, as if the accounts were assigned to different users. Details in one embodiment regarding the configuration of real time interactions using multiple accounts of a user are provided in the section entitled “MULTIPLE ACCOUNTS.”

In one embodiment, the computing apparatus is configured to target the same offer differently to users based on the media channels used to deliver the offer. An offer can be configured to include first qualification conditions formulated based on triggering events, such as the current location of a user, the current transaction of the user as being processed by a transaction handler, and second qualification conditions not based on such triggering events. To users reachable via a first set of media channels, the first qualification conditions are ignored in selecting candidate users for the delivery of the offer; and the candidate users are selected based on the second qualification conditions. If the offer has not be delivered to a user via the first set of media channels, the computing apparatus is configured to deliver the offer to the user via a second set of media channels, when the user satisfies both the first qualification conditions and the second qualification conditions. Details in one embodiment are provided in the section entitled “MULTIPLE MEDIA CHANNELS.”

In one embodiment, a system and method is configured to allow an offer campaign to be specified based on requirements of transactions with multiple merchants. Details in one embodiment are provided in the section entitled “MULTIPLE MERCHANTS.”

In one embodiment, the computing apparatus correlates transactions with activities that occurred outside the context of the transaction, such as online advertisements presented to the customers that at least in part cause offline transactions. The correlation data can be used to demonstrate the success of the advertisements, and/or to improve intelligence information about how individual customers and/or various types or groups of customers respond to the advertisements.

In one embodiment, the computing apparatus correlates, or provides information to facilitate the correlation of, transactions with online activities of the customers, such as searching, web browsing, social networking and consuming advertisements, with other activities, such as watching television programs, and/or with events, such as meetings, announcements, natural disasters, accidents, news announcements, etc.

In one embodiment, the correlation results are used in predictive models to predict transactions and/or spending patterns based on activities or events, to predict activities or events based on transactions or spending patterns, to provide alerts or reports, etc.

In one embodiment, a single entity operating the transaction handler performs various operations in the services provided based on the transaction data. For example, in the presentation of the personalized or targeted advertisements, the single entity may perform the operations such as generating the intelligence information, selecting relevant intelligence information for a given audience, selecting, identifying, adjusting, prioritizing, personalizing and/or generating advertisements based on selected relevant intelligence information, and facilitating the delivery of personalized or targeted advertisements, etc. Alternatively, the entity operating the transaction handler cooperates with one or more other entities by providing information to these entities to allow these entities to perform at least some of the operations for presentation of the personalized or targeted advertisements.

### Transaction Data Based Services

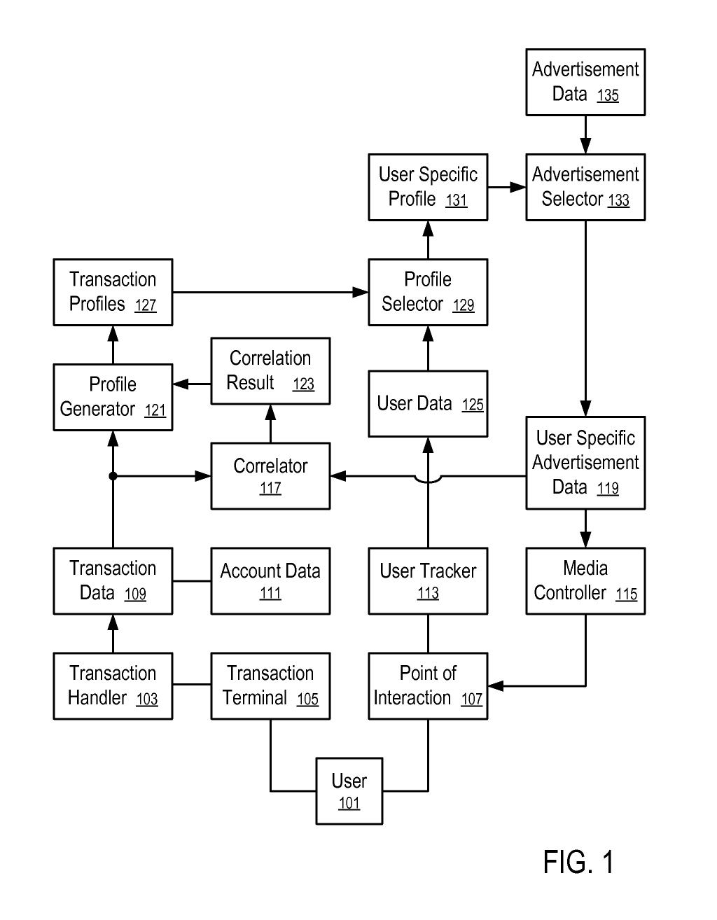

FIG. 1 illustrates a system to provide services based on transaction data according to one embodiment. In FIG. 1, the system includes a transaction terminal (105) to initiate financial transactions for a user (101), a transaction handler (103) to generate transaction data (109) from processing the financial transactions of the user (101) (and the financial transactions of other users), a profile generator (121) to generate transaction profiles (127) based on the transaction data (109) to provide information/intelligence about user preferences and spending patterns, a point of interaction (107) to provide information and/or offers to the user (101), a user tracker (113) to generate user data (125) to identify the user (101) using the point of interaction (107), a profile selector (129) to select a profile (131) specific to the user (101) identified by the user data (125), and an advertisement selector (133) to select, identify, generate, adjust, prioritize and/or personalize advertisements for presentation to the user (101) on the point of interaction (107) via a media controller (115).

In FIG. 1, the system further includes a correlator (117) to correlate user specific advertisement data (119) with transactions resulting from the user specific advertisement data (119). The correlation results (123) can be used by the profile generator (121) to improve the transaction profiles (127).

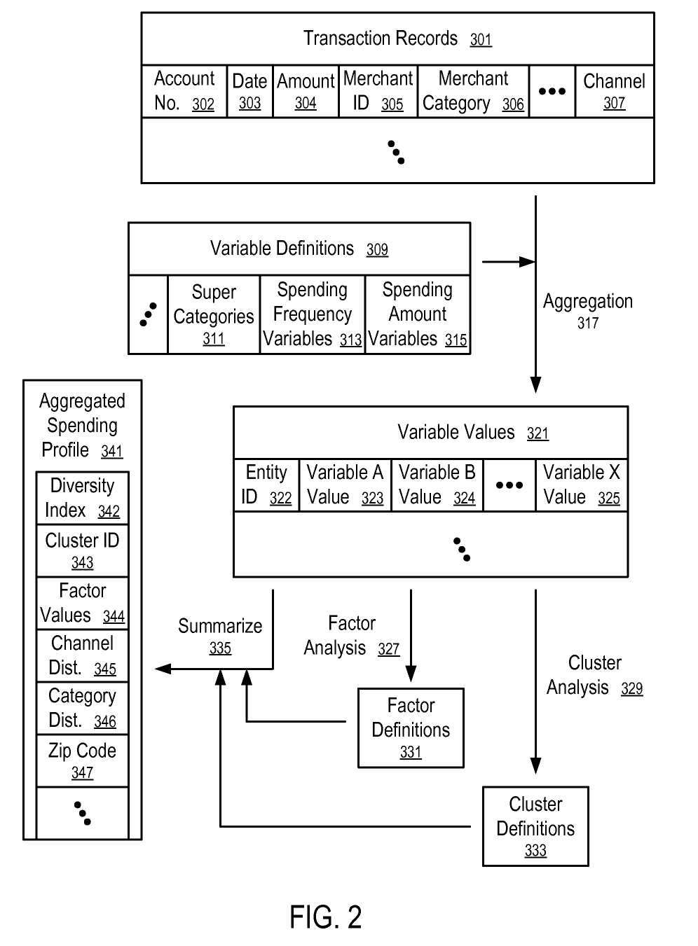

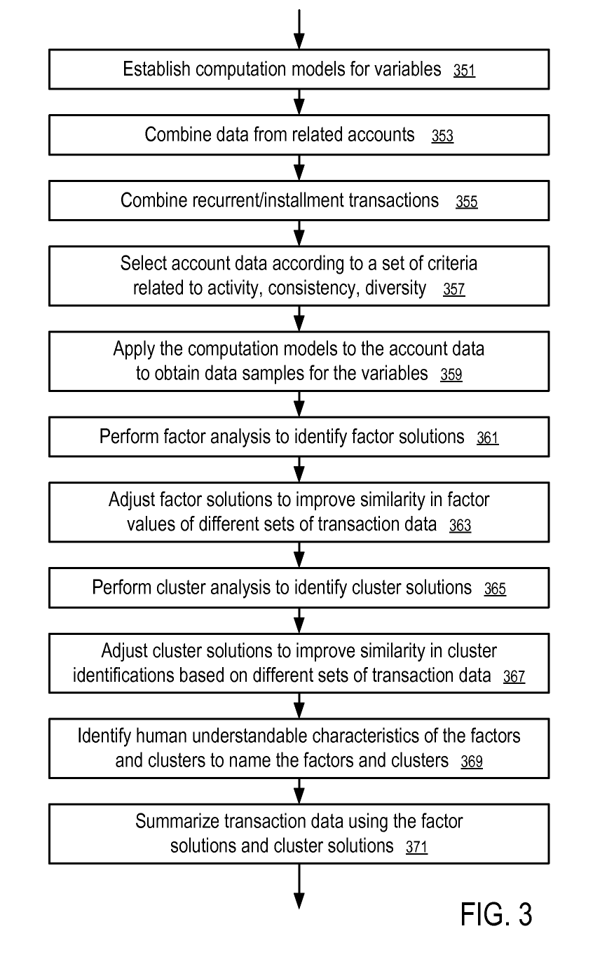

The transaction profiles (127) of one embodiment are generated from the transaction data (109) in a way as illustrated in FIGS. 2 and 3. For example, in FIG. 2, an aggregated spending profile (341) is generated via the factor analysis (327) and cluster analysis (329) to summarize (335) the spending patterns/behaviors reflected in the transaction records (301).

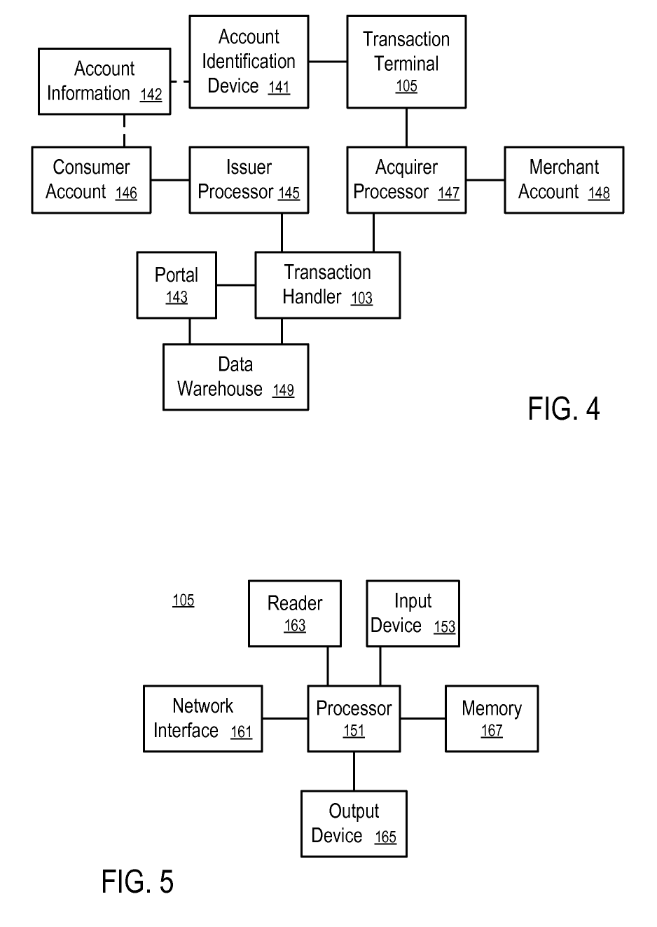

In one embodiment, a data warehouse (149) as illustrated in FIG. 4 is coupled with the transaction handler (103) to store the transaction data (109) and other data, such as account data (111), transaction profiles (127) and correlation results (123). In FIG. 4, a portal (143) is coupled with the data warehouse (149) to provide data or information derived from the transaction data (109), in response to a query request from a third party or as an alert or notification message.

In FIG. 4, the transaction handler (103) is coupled between an issuer processor (145) in control of a consumer account (146) and an acquirer processor (147) in control of a merchant account (148). An account identification device (141) is configured to carry the account information (142) that identifies the consumer account (146) with the issuer processor (145) and provide the account information (142) to the transaction terminal (105) of a merchant to initiate a transaction between the user (101) and the merchant.

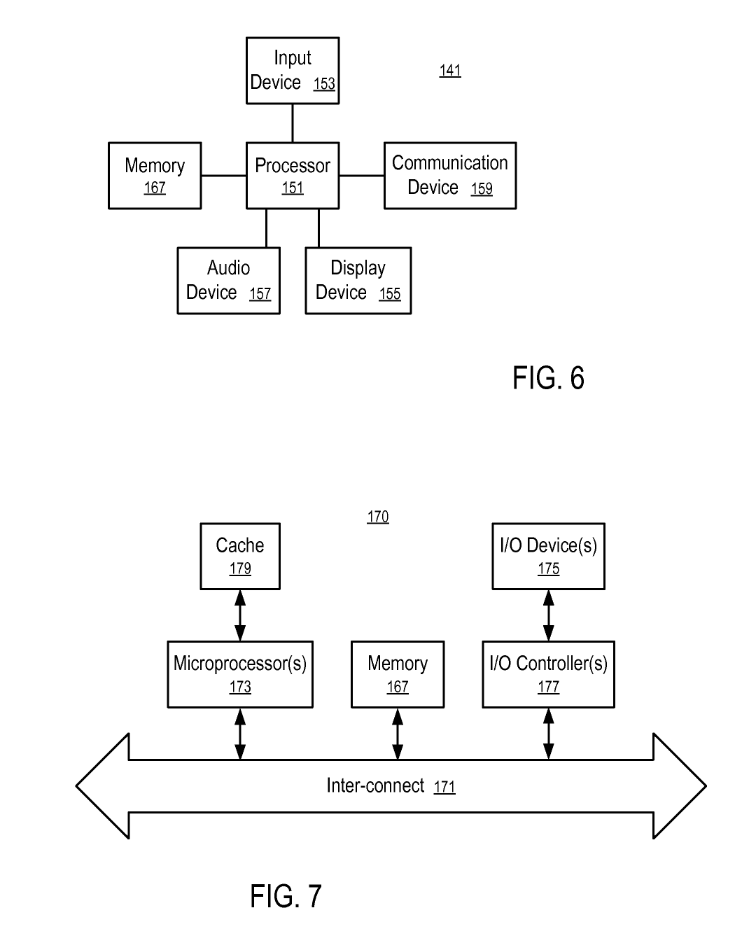

FIGS. 5 and 6 illustrate examples of transaction terminals (105) and account identification devices (141). FIG. 7 illustrates the structure of a data processing system (170) that can be used to implement, with more or fewer elements, at least some of the components in the system, such as the point of interaction (107), the transaction handler (103), the portal (143), the data warehouse, the account identification device (141), the transaction terminal (105), the user tracker (113), the profile generator (121), the profile selector (129), the advertisement selector (133), the media controller (115), etc. Some embodiments use more or fewer components than those illustrated, such as, in FIGS. 1, 4-7, and other figures, as further discussed in the section entitled “VARIATIONS.”

In one embodiment, the transaction data (109) relates to financial transactions processed by the transaction handler (103); and the account data (111) relates to information about the account holders involved in the transactions. Further data, such as merchant data that relates to the location, business, products and/or services of the merchants that receive payments from account holders for their purchases, can be used in the generation of the transaction profiles (127, 341).

In one embodiment, the financial transactions are made via an account identification device (141), such as financial transaction cards (e.g., credit cards, debit cards, banking cards, etc.); the financial transaction cards may be embodied in various devices, such as plastic cards, chips, radio frequency identification (RFID) devices, mobile phones, personal digital assistants (PDAs), etc.; and the financial transaction cards may be represented by account identifiers (e.g., account numbers or aliases). In one embodiment, the financial transactions are made via directly using the account information (142), without physically presenting the account identification device (141).

Further features, modifications and details are provided in various sections of this description.

### Centralized Data Warehouse

In one embodiment, the transaction handler (103) couples with a centralized data warehouse (149) organized around the transaction data (109). For example, the centralized data warehouse (149) may include, and/or support the determination of, spend band distribution, transaction count and amount, merchant categories, merchant by state, cardholder segmentation by velocity scores, and spending within merchant target, competitive set and cross-section. For example, the centralized data warehouse (149) may include the advertisement data (135) and/or offers of benefits such as discount, reward, points, cashback, etc. The offers can be communicated to the users (e.g., 101) via the advertisement data (135) or as part of the advertisement data (135).

In one embodiment, the centralized data warehouse (149) provides centralized management but allows decentralized execution. For example, a third party strategic marketing analyst, statistician, marketer, promoter, business leader, etc., may access the centralized data warehouse (149) to analyze customer and shopper data, to provide follow-up analyses of customer contributions, to develop propensity models for increased conversion of marketing campaigns, to develop segmentation models for marketing, etc. The centralized data warehouse (149) can be used to manage advertisement campaigns and analyze response profitability.

In one embodiment, the centralized data warehouse (149) includes merchant data (e.g., data about sellers), customer/business data (e.g., data about buyers), and transaction records (301) between sellers and buyers over time. The centralized data warehouse (149) can be used to support corporate sales forecasting, fraud analysis reporting, sales/customer relationship management (CRM) business intelligence, credit risk prediction and analysis, advanced authorization reporting, merchant benchmarking, business intelligence for small business, rewards, etc.

In one embodiment, the transaction data (109) is combined with external data, such as surveys, benchmarks, search engine statistics, demographics, competition information, emails, etc., to flag key events and data values, to set customer, merchant, data or event triggers, and to drive new transactions and new customer contacts.

### Transaction Profile

In FIG. 1, the profile generator (121) generates transaction profiles (127) based on the transaction data (109), the account data (111), and/or other data, such as non-transactional data, wish lists, merchant provided information, address information, information from social network websites, information from credit bureaus, information from search engines, and other examples discussed in U.S. patent application Ser. No. 12/614,603, filed Nov. 9, 2009, assigned U.S. Pat. App. Pub. No. 2011/0054981, and entitled “Analyzing Local Non-Transactional Data with Transactional Data in Predictive Models,” the disclosure of which is hereby incorporated herein by reference.

In one embodiment, the transaction profiles (127) provide intelligence information on the behavior, pattern, preference, propensity, tendency, frequency, trend, and budget of the user (101) in making purchases. In one embodiment, the transaction profiles (127) include information about what the user (101) owns, such as points, miles, or other rewards currency, available credit, and received offers, such as coupons loaded into the accounts of the user (101). In one embodiment, the transaction profiles (127) include information based on past offer/coupon redemption patterns. In one embodiment, the transaction profiles (127) include information on shopping patterns in retail stores as well as online, including frequency of shopping, amount spent in each shopping trip, distance of merchant location (retail) from the address of the account holder(s), etc.

In one embodiment, the transaction handler (103) (and/or the portal (143)) is configured to provide at least part of the intelligence for the prioritization, generation, selection, customization and/or adjustment of the advertisement for delivery within a transaction process involving the transaction handler (103). For example, the advertisement may be presented to a customer in response to the customer making a payment via the transaction handler (103).

Some of the transaction profiles (127) are specific to the user (101), or to an account of the user (101), or to a group of users of which the user (101) is a member, such as a household, family, company, neighborhood, city, or group identified by certain characteristics related to online activities, offline purchase activities, merchant propensity, etc.

The profile generator (121) may generate and update the transaction profiles (127) in batch mode periodically, or generates the transaction profiles (127) in real time, or just in time, in response to a request received in the portal (143) for such profiles.

The transaction profiles (127) of one embodiment include the values for a set of parameters. Computing the values of the parameters may involve counting transactions that meet one or more criteria, and/or building a statistically-based model in which one or more calculated values or transformed values are put into a statistical algorithm that weights each value to optimize its collective predictiveness for various predetermined purposes.

Further details and examples about the transaction profiles (127) in one embodiment are provided in the section entitled “AGGREGATED SPENDING PROFILE.”

### Non-Transactional Data

In one embodiment, the transaction data (109) is analyzed in connection with non-transactional data to generate transaction profiles (127) and/or to make predictive models.

In one embodiment, transactions are correlated with non-transactional events, such as news, conferences, shows, announcements, market changes, natural disasters, etc. to establish cause and effect relations to predict future transactions or spending patterns. For example, non-transactional data may include the geographic location of a news event, the date of an event from an events calendar, the name of a performer for an upcoming concert, etc. The non-transactional data can be obtained from various sources, such as newspapers, websites, blogs, social networking sites, etc.

When the cause and effect relationships between the transactions and non-transactional events are known (e.g., based on prior research results, domain knowledge, expertise), the relationships can be used in predictive models to predict future transactions or spending patterns, based on events that occurred recently or are happening in real time.

In one embodiment, the non-transactional data relates to events that happened in a geographical area local to the user (101) that performed the respective transactions. In one embodiment, a geographical area is local to the user (101) when the distance from the user (101) to locations in the geographical area is within a convenient range for daily or regular travel, such as 20, 50 or 100 miles from an address of the user (101), or within the same city or zip code area of an address of the user (101). Examples of analyses of local non-transactional data in connection with transaction data (109) in one embodiment are provided in U.S. patent application Ser. No. 12/614,603, filed Nov. 9, 2009, assigned U.S. Pat. App. Pub. No. 2011/0054981, and entitled “Analyzing Local Non-Transactional Data with Transactional Data in Predictive Models,” the disclosure of which is hereby incorporated herein by reference.

In one embodiment, the non-transactional data is not limited to local non-transactional data. For example, national non-transactional data can also be used.

In one embodiment, the transaction records (301) are analyzed in frequency domain to identify periodic features in spending events. The periodic features in the past transaction records (301) can be used to predict the probability of a time window in which a similar transaction would occur. For example, the analysis of the transaction data (109) can be used to predict when a next transaction having the periodic feature would occur, with which merchant, the probability of a repeated transaction with a certain amount, the probability of exception, the opportunity to provide an advertisement or offer such as a coupon, etc. In one embodiment, the periodic features are detected through counting the number of occurrences of pairs of transactions that occurred within a set of predetermined time intervals and separating the transaction pairs based on the time intervals. Some examples and techniques for the prediction of future transactions based on the detection of periodic features in one embodiment are provided in U.S. patent application Ser. No. 12/773,770, filed May 4, 2010, assigned U.S. Pat. App. Pub. No. 2010/0280882, and entitled “Frequency-Based Transaction Prediction and Processing,” the disclosure of which is hereby incorporated herein by reference.

Techniques and details of predictive modeling in one embodiment are provided in U.S. Pat. Nos. 6,119,103, 6,018,723, 6,658,393, 6,598,030, and 7,227,950, the disclosures of which are hereby incorporated herein by reference.

In one embodiment, offers are based on the point-of-service to offeree distance to allow the user (101) to obtain in-person services. In one embodiment, the offers are selected based on transaction history and shopping patterns in the transaction data (109) and/or the distance between the user (101) and the merchant. In one embodiment, offers are provided in response to a request from the user (101), or in response to a detection of the location of the user (101). Examples and details of at least one embodiment are provided in U.S. patent application Ser. No. 11/767,218, filed Jun. 22, 2007, assigned U.S. Pat. App. Pub. No. 2008/0319843, and entitled “Supply of Requested Offer Based on Point-of Service to Offeree Distance,” U.S. patent application Ser. No. 11/755,575, filed May 30, 2007, assigned U.S. Pat. App. Pub. No. 2008/0300973, and entitled “Supply of Requested Offer Based on Offeree Transaction History,” U.S. patent application Ser. No. 11/855,042, filed Sep. 13, 2007, assigned U.S. Pat. App. Pub. No. 2009/0076896, and entitled “Merchant Supplied Offer to a Consumer within a Predetermined Distance,” U.S. patent application Ser. No. 11/855,069, filed Sep. 13, 2007, assigned U.S. Pat. App. Pub. No. 2009/0076925, and entitled “Offeree Requested Offer Based on Point-of Service to Offeree Distance,” and U.S. patent application Ser. No. 12/428,302, filed Apr. 22, 2009, assigned U.S. Pat. App. Pub. No. 2010/0274627, and entitled “Receiving an Announcement Triggered by Location Data,” the disclosures of which applications are hereby incorporated herein by reference.

### Targeting Advertisement

In FIG. 1, an advertisement selector (133) prioritizes, generates, selects, adjusts, and/or customizes the available advertisement data (135) to provide user specific advertisement data (119) based at least in part on the user specific profile (131). The advertisement selector (133) uses the user specific profile (131) as a filter and/or a set of criteria to generate, identify, select and/or prioritize advertisement data for the user (101). A media controller (115) delivers the user specific advertisement data (119) to the point of interaction (107) for presentation to the user (101) as the targeted and/or personalized advertisement.

In one embodiment, the user data (125) includes the characterization of the context at the point of interaction (107). Thus, the use of the user specific profile (131), selected using the user data (125), includes the consideration of the context at the point of interaction (107) in selecting the user specific advertisement data (119).

In one embodiment, in selecting the user specific advertisement data (119), the advertisement selector (133) uses not only the user specific profile (131), but also information regarding the context at the point of interaction (107). For example, in one embodiment, the user data (125) includes information regarding the context at the point of interaction (107); and the advertisement selector (133) explicitly uses the context information in the generation or selection of the user specific advertisement data (119).

In one embodiment, the advertisement selector (133) may query for specific information regarding the user (101) before providing the user specific advertisement data (119). The queries may be communicated to the operator of the transaction handler (103) and, in particular, to the transaction handler (103) or the profile generator (121). For example, the queries from the advertisement selector (133) may be transmitted and received in accordance with an application programming interface or other query interface of the transaction handler (103), the profile generator (121) or the portal (143) of the transaction handler (103).

In one embodiment, the queries communicated from the advertisement selector (133) may request intelligence information regarding the user (101) at any level of specificity (e.g., segment level, individual level). For example, the queries may include a request for a certain field or type of information in a cardholder's aggregate spending profile (341). As another example, the queries may include a request for the spending level of the user (101) in a certain merchant category over a prior time period (e.g., six months).

In one embodiment, the advertisement selector (133) is operated by an entity that is separate from the entity that operates the transaction handler (103). For example, the advertisement selector (133) may be operated by a search engine, a publisher, an advertiser, an ad network, or an online merchant. The user specific profile (131) is provided to the advertisement selector (133) to assist the customization of the user specific advertisement data (119).

In one embodiment, advertising is targeted based on shopping patterns in a merchant category (e.g., as represented by a Merchant Category Code (MCC)) that has high correlation of spending propensity with other merchant categories (e.g., other MCCs). For example, in the context of a first MCC for a targeted audience, a profile identifying second MCCs that have high correlation of spending propensity with the first MCC can be used to select advertisements for the targeted audience.

In one embodiment, the aggregated spending profile (341) is used to provide intelligence information about the spending patterns, preferences, and/or trends of the user (101). For example, a predictive model can be established based on the aggregated spending profile (341) to estimate the needs of the user (101). For example, the factor values (344) and/or the cluster ID (343) in the aggregated spending profile (341) can be used to determine the spending preferences of the user (101). For example, the channel distribution (345) in the aggregated spending profile (341) can be used to provide a customized offer targeted for a particular channel, based on the spending patterns of the user (101).

In one embodiment, mobile advertisements, such as offers and coupons, are generated and disseminated based on aspects of prior purchases, such as timing, location, and nature of the purchases, etc. In one embodiment, the size of the benefit of the offer or coupon is based on purchase volume or spending amount of the prior purchase and/or the subsequent purchase that may qualify for the redemption of the offer. Further details and examples of one embodiment are provided in U.S. patent application Ser. No. 11/960,162, filed Dec. 19, 2007, assigned U.S. Pat. App. Pub. No. 2008/0201226, and entitled “Mobile Coupon Method and Portable Consumer Device for Utilizing Same,” the disclosure of which is hereby incorporated herein by reference.

In one embodiment, conditional rewards are provided to the user (101); and the transaction handler (103) monitors the transactions of the user (101) to identify redeemable rewards that have satisfied the respective conditions. In one embodiment, the conditional rewards are selected based on transaction data (109). Further details and examples of one embodiment are provided in U.S. patent application Ser. No. 11/862,487, filed Sep. 27, 2007, assigned U.S. Pat. App. Pub. No. 2008/0082418, and entitled “Consumer Specific Conditional Rewards,” the disclosure of which is hereby incorporated herein by reference. The techniques to detect the satisfied conditions of conditional rewards can also be used to detect the transactions that satisfy the conditions specified to locate the transactions that result from online activities, such as online advertisements, searches, etc., to correlate the transactions with the respective online activities.

Further details about targeted offer delivery in one embodiment are provided in U.S. patent application Ser. No. 12/185,332, filed Aug. 4, 2008, assigned U.S. Pat. App. Pub. No. 2010/0030644, and entitled “Targeted Advertising by Payment Processor History of Cashless Acquired Merchant Transaction on Issued Consumer Account,” and in U.S. patent application Ser. No. 12/849,793, filed Aug. 3, 2010, assigned U.S. Pat. App. Pub. No. 2011/0035280, and entitled “Systems and Methods for Targeted Advertisement Delivery,” the disclosures of which applications are hereby incorporated herein by reference.

### Profile Matching

In FIG. 1, the user tracker (113) obtains and generates context information about the user (101) at the point of interaction (107), including user data (125) that characterizes and/or identifies the user (101). The profile selector (129) selects a user specific profile (131) from the set of transaction profiles (127) generated by the profile generator (121), based on matching the characteristics of the transaction profiles (127) and the characteristics of the user data (125). For example, the user data (125) indicates a set of characteristics of the user (101); and the profile selector (129) selects the user specific profile (131) that is for a particular user or a group of users and that best matches the set of characteristics specified by the user data (125).

In one embodiment, the profile selector (129) receives the transaction profiles (127) in a batch mode. The profile selector (129) selects the user specific profile (131) from the batch of transaction profiles (127) based on the user data (125). Alternatively, the profile generator (121) generates the transaction profiles (127) in real time; and the profile selector (129) uses the user data (125) to query the profile generator (121) to generate the user specific profile (131) in real time, or just in time. The profile generator (121) generates the user specific profile (131) that best matches the user data (125).

In one embodiment, the user tracker (113) identifies the user (101) based on the user activity on the transaction terminal (105) (e.g., having visited a set of websites, currently visiting a type of web pages, search behavior, etc.).

In one embodiment, the user data (125) includes an identifier of the user (101), such as a global unique identifier (GUID), a personal account number (PAN) (e.g., credit card number, debit card number, or other card account number), or other identifiers that uniquely and persistently identify the user (101) within a set of identifiers of the same type. Alternatively, the user data (125) may include other identifiers, such as an Internet Protocol (IP) address of the user (101), a name or user name of the user (101), or a browser cookie ID, which identify the user (101) in a local, temporary, transient and/or anonymous manner. Some of these identifiers of the user (101) may be provided by publishers, advertisers, ad networks, search engines, merchants, or the user tracker (113). In one embodiment, such identifiers are correlated to the user (101) based on the overlapping or proximity of the time period of their usage to establish an identification reference table.

In one embodiment, the identification reference table is used to identify the account information (142) (e.g., account number (302)) based on characteristics of the user (101) captured in the user data (125), such as browser cookie ID, IP addresses, and/or timestamps on the usage of the IP addresses. In one embodiment, the identification reference table is maintained by the operator of the transaction handler (103). Alternatively, the identification reference table is maintained by an entity other than the operator of the transaction handler (103).

In one embodiment, the user tracker (113) determines certain characteristics of the user (101) to describe a type or group of users of which the user (101) is a member. The transaction profile of the group is used as the user specific profile (131). Examples of such characteristics include geographical location or neighborhood, types of online activities, specific online activities, or merchant propensity. In one embodiment, the groups are defined based on aggregate information (e.g., by time of day, or household), or segment (e.g., by cluster, propensity, demographics, cluster IDs, and/or factor values). In one embodiment, the groups are defined in part via one or more social networks. For example, a group may be defined based on social distances to one or more users on a social network website, interactions between users on a social network website, and/or common data in social network profiles of the users in the social network website.

In one embodiment, the user data (125) may match different profiles at a different granularity or resolution (e.g., account, user, family, company, neighborhood, etc.), with different degrees of certainty. The profile selector (129) and/or the profile generator (121) may determine or select the user specific profile (131) with the finest granularity or resolution with acceptable certainty. Thus, the user specific profile (131) is most specific or closely related to the user (101).

In one embodiment, the advertisement selector (133) uses further data in prioritizing, selecting, generating, customizing and adjusting the user specific advertisement data (119). For example, the advertisement selector (133) may use search data in combination with the user specific profile (131) to provide benefits or offers to a user (101) at the point of interaction (107). For example, the user specific profile (131) can be used to personalize the advertisement, such as adjusting the placement of the advertisement relative to other advertisements, adjusting the appearance of the advertisement, etc.

### Browser Cookie

In one embodiment, the user data (125) uses browser cookie information to identify the user (101). The browser cookie information is matched to account information (142) or the account number (302) to identify the user specific profile (131), such as aggregated spending profile (341) to present effective, timely, and relevant marketing information to the user (101), via the preferred communication channel (e.g., mobile communications, web, mail, email, POS, etc.) within a window of time that could influence the spending behavior of the user (101). Based on the transaction data (109), the user specific profile (131) can improve audience targeting for online advertising. Thus, customers will get better advertisements and offers presented to them; and the advertisers will achieve better return-on-investment for their advertisement campaigns.

In one embodiment, the browser cookie that identifies the user (101) in online activities, such as web browsing, online searching, and using social networking applications, can be matched to an identifier of the user (101) in account data (111), such as the account number (302) of a financial payment card of the user (101) or the account information (142) of the account identification device (141) of the user (101). In one embodiment, the identifier of the user (101) can be uniquely identified via matching IP address, timestamp, cookie ID and/or other user data (125) observed by the user tracker (113).

In one embodiment, a look up table is used to map browser cookie information (e.g., IP address, timestamp, cookie ID) to the account data (111) that identifies the user (101) in the transaction handler (103). The look up table may be established via correlating overlapping or common portions of the user data (125) observed by different entities or different user trackers (113).

In one embodiment, the portal (143) is configured to identify the consumer account (146) based on the IP address identified in the user data (125) through mapping the IP address to a street address.

In one embodiment, the portal (143) uses a plurality of methods to identify consumer accounts (146) based on the user data (125). The portal (143) combines the results from the different methods to determine the most likely consumer account (146) for the user data (125).

Details about the identification of consumer account (146) based on user data (125) in one embodiment are provided in U.S. patent application Ser. No. 12/849,798, filed Aug. 3, 2010, assigned U.S. Pat. App. Pub. No. 2011/0093327, and entitled “Systems and Methods to Match Identifiers,” the disclosure of which is hereby incorporated herein by reference.

### Close the Loop

In one embodiment, the correlator (117) is used to “close the loop” for the tracking of consumer behavior across an on-line activity and an “off-line” activity that results at least in part from the on-line activity. In one embodiment, online activities, such as searching, web browsing, social networking, and/or consuming online advertisements, are correlated with respective transactions to generate the correlation result (123) in FIG. 1. The respective transactions may occur offline, in “brick and mortar” retail stores, or online but in a context outside the online activities, such as a credit card purchase that is performed in a way not visible to a search company that facilitates the search activities.

The correlator (117) is configured in one embodiment to identify transactions resulting from searches or online advertisements. For example, in response to a query about the user (101) from the user tracker (113), the correlator (117) identifies an offline transaction performed by the user (101) and sends the correlation result (123) about the offline transaction to the user tracker (113), which allows the user tracker (113) to combine the information about the offline transaction and the online activities to provide significant marketing advantages.

For example, a marketing department could correlate an advertising budget to actual sales. For example, a marketer can use the correlation result (123) to study the effect of certain prioritization strategies, customization schemes, etc. on the impact on the actual sales. For example, the correlation result (123) can be used to adjust or prioritize advertisement placement on a web site, a search engine, a social networking site, an online marketplace, or the like.

In one embodiment, the profile generator (121) uses the correlation result (123) to augment the transaction profiles (127) with data indicating the rate of conversion from searches or advertisements to purchase transactions. In one embodiment, the correlation result (123) is used to generate predictive models to determine what a user (101) is likely to purchase when the user (101) is searching using certain keywords or when the user (101) is presented with an advertisement or offer. In one embodiment, the portal (143) is configured to report the correlation result (123) to a partner, such as a search engine, a publisher, or a merchant, to allow the partner to use the correlation result (123) to measure the effectiveness of advertisements and/or search result customization, to arrange rewards, etc.

In one embodiment, the correlator (117) matches the online activities and the transactions based on matching the user data (125) provided by the user tracker (113) and the records of the transactions, such as transaction data (109) or transaction records (301). In another embodiment, the correlator (117) matches the online activities and the transactions based on the redemption of offers/benefits provided in the user specific advertisement data (119).

In one embodiment, the portal (143) is configured to receive a set of conditions and an identification of the user (101), determine whether there is any transaction of the user (101) that satisfies the set of conditions, and if so, provide indications of the transactions that satisfy the conditions and/or certain details about the transactions, which allows the requester to correlate the transactions with certain user activities, such as searching, web browsing, consuming advertisements, etc.

In one embodiment, the requester may not know the account number (302) of the user (101); and the portal (143) is to map the identifier provided in the request to the account number (302) of the user (101) to provide the requested information. Examples of the identifier being provided in the request to identify the user (101) include an identification of an iFrame of a web page visited by the user (101), a browser cookie ID, an IP address and the day and time corresponding to the use of the IP address, etc.

The information provided by the portal (143) can be used in pre-purchase marketing activities, such as customizing content or offers, prioritizing content or offers, selecting content or offers, etc., based on the spending pattern of the user (101). The content that is customized, prioritized, selected, or recommended may be the search results, blog entries, items for sale, etc.

The information provided by the portal (143) can be used in post-purchase activities. For example, the information can be used to correlate an offline purchase with online activities. For example, the information can be used to determine purchases made in response to media events, such as television programs, advertisements, news announcements, etc.

Details about profile delivery, online activity to offline purchase tracking, techniques to identify the user specific profile (131) based on user data (125) (such as IP addresses), and targeted delivery of advertisement/offer/benefit in some embodiments are provided in U.S. patent application Ser. No. 12/849,789, filed Aug. 3, 2010, assigned U.S. Pat. App. Pub. No. 2011/0035278, and entitled “Systems and Methods for Closing the Loop between Online Activities and Offline Purchases,” the disclosure of which application is incorporated herein by reference.

### Loyalty Program

In one embodiment, the transaction handler (103) uses the account data (111) to store information for third party loyalty programs.

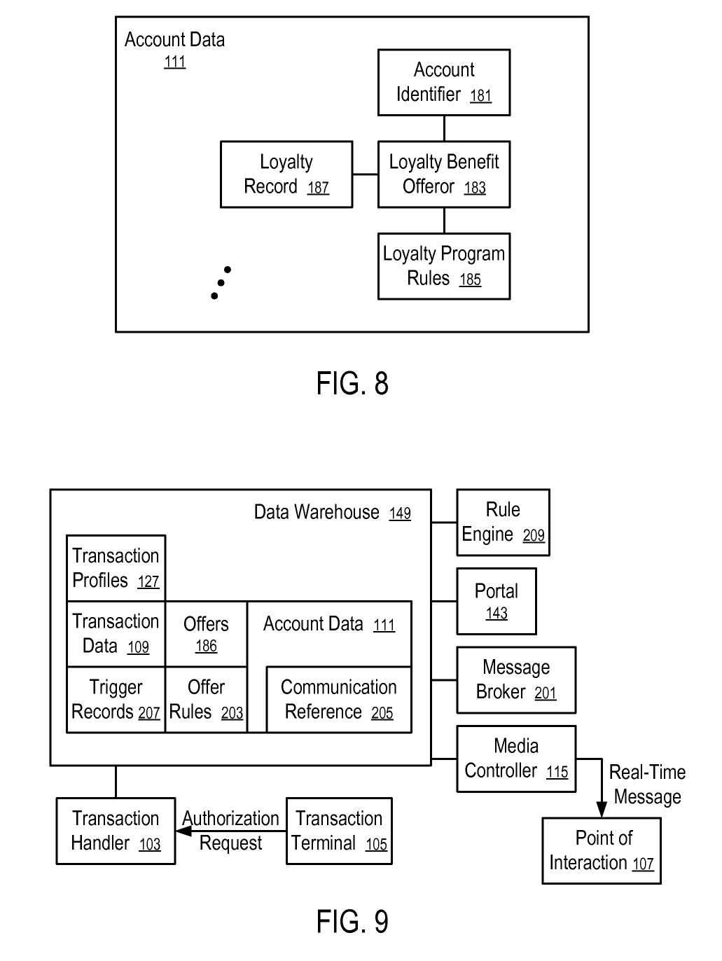

FIG. 8 shows the structure of account data (111) for providing loyalty programs according to one embodiment. In FIG. 8, data related to a third party loyalty program may include an identifier of the loyalty benefit offeror (183) that is linked to a set of loyalty program rules (185) and loyalty record (187) for the loyalty program activities of the account identifier (181). In one embodiment, at least part of the data related to the third party loyalty program is stored under the account identifier (181) of the user (101), such as the loyalty record (187).

FIG. 8 illustrates the data related to one third party loyalty program of a loyalty benefit offeror (183). In one embodiment, the account identifier (181) may be linked to multiple loyalty benefit offerors (e.g., 183), corresponding to different third party loyalty programs. The third party loyalty program of the loyalty benefit offeror (183) provides the user (101), identified by the account identifier (181), with benefits, such as discounts, rewards, incentives, cash back, gifts, coupons, and/or privileges.

In one embodiment, the association between the account identifier (181) and the loyalty benefit offeror (183) in the account data (111) indicates that the user (101) having the account identifier (181) is a member of the loyalty program. Thus, the user (101) may use the account identifier (181) to access privileges afforded to the members of the loyalty programs, such as rights to access a member only area, facility, store, product or service, discounts extended only to members, or opportunities to participate in certain events, buy certain items, or receive certain services reserved for members.

In one embodiment, it is not necessary to make a purchase to use the privileges. The user (101) may enjoy the privileges based on the status of being a member of the loyalty program. The user (101) may use the account identifier (181) to show the status of being a member of the loyalty program.

For example, the user (101) may provide the account identifier (181) (e.g., the account number of a credit card) to the transaction terminal (105) to initiate an authorization process for a special transaction which is designed to check the member status of the user (101), as if the account identifier (181) were used to initiate an authorization process for a payment transaction. The special transaction is designed to verify the member status of the user (101) via checking whether the account data (111) is associated with the loyalty benefit offeror (183). If the account identifier (181) is associated with the corresponding loyalty benefit offeror (183), the transaction handler (103) provides an approval indication in the authorization process to indicate that the user (101) is a member of the loyalty program. The approval indication can be used as a form of identification to allow the user (101) to access member privileges, such as access to services, products, opportunities, facilities, discounts, permissions, which are reserved for members.

In one embodiment, when the account identifier (181) is used to identify the user (101) as a member to access member privileges, the transaction handler (103) stores information about the access of the corresponding member privilege in loyalty record (187). The profile generator (121) may use the information accumulated in the loyalty record (187) to enhance transaction profiles (127) and provide the user (101) with personalized/targeted advertisements, with or without further offers of benefit (e.g., discounts, incentives, rebates, cash back, rewards, etc.).

In one embodiment, the association of the account identifier (181) and the loyalty benefit offeror (183) also allows the loyalty benefit offeror (183) to access at least a portion of the account data (111) relevant to the loyalty program, such as the loyalty record (187) and certain information about the user (101), such as name, address, and other demographic data.

In one embodiment, the loyalty program allows the user (101) to accumulate benefits according to loyalty program rules (185), such as reward points, cash back, levels of discounts, etc. For example, the user (101) may accumulate reward points for transactions that satisfy the loyalty program rules (185); and the user (101) may use the reward points to redeem cash, gift, discounts, etc. In one embodiment, the loyalty record (187) stores the accumulated benefits; and the transaction handler (103) updates the loyalty record (187) associated with the loyalty benefit offeror (183) and the account identifier (181), when events that satisfy the loyalty program rules occur.

In one embodiment, the accumulated benefits as indicated in the loyalty record (187) can be redeemed when the account identifier (181) is used to perform a payment transaction, when the payment transaction satisfies the loyalty program rules. For example, the user (101) may redeem a number of points to offset or reduce an amount of the purchase price.

In one embodiment, when the user (101) uses the account identifier (181) to make purchases as a member, the merchant may further provide information about the purchases; and the transaction handler (103) can store the information about the purchases as part of the loyalty record (187). The information about the purchases may identify specific items or services purchased by the member. For example, the merchant may provide the transaction handler (103) with purchase details at stock-keeping unit (SKU) level, which are then stored as part of the loyalty record (187). The loyalty benefit offeror (183) may use the purchase details to study the purchase behavior of the user (101); and the profile generator (121) may use the SKU level purchase details to enhance the transaction profiles (127).

In one embodiment, the SKU level purchase details are requested from the merchants or retailers via authorization responses, when the account (146) of the user (101) is enrolled in a loyalty program that allows the transaction handler (103) (and/or the issuer processor (145)) to collect the purchase details.

A method to provide loyalty programs of one embodiment includes the use of the transaction handler (103) as part of a computing apparatus. The computing apparatus processes a plurality of payment card transactions. After the computing apparatus receives a request to track transactions for a loyalty program, such as the loyalty program rules (185), the computing apparatus stores and updates loyalty program information in response to transactions occurring in the loyalty program. The computing apparatus provides to a customer (e.g., 101) an offer of a benefit when the customer satisfies a condition defined in the loyalty program, such as the loyalty program rules (185). In one embodiment, the loyalty benefit as identified in the loyalty record (187) can be redeemed in connection with a transaction in a way the benefit of an offer stored in association with the account identifier (181) is redeemed.

Examples of loyalty programs through collaboration between collaborative constituents in a payment processing system, including the transaction handler (103) in one embodiment are provided in U.S. patent application Ser. No. 11/767,202, filed Jun. 22, 2007, assigned U.S. Pat. App. Pub. No. 2008/0059302, and entitled “Loyalty Program Service,” U.S. patent application Ser. No. 11/848,112, filed Aug. 30, 2007, assigned U.S. Pat. App. Pub. No. 2008/0059306, and entitled “Loyalty Program Incentive Determination,” and U.S. patent application Ser. No. 11/848,179, filed Aug. 30, 2007, assigned U.S. Pat. App. Pub. No. 2008/0059307, and entitled “Loyalty Program Parameter Collaboration,” the disclosures of which applications are hereby incorporated herein by reference.

Examples of processing the redemption of accumulated loyalty benefits via the transaction handler (103) in one embodiment are provided in U.S. patent application Ser. No. 11/835,100, filed Aug. 7, 2007, assigned U.S. Pat. App. Pub. No. 2008/0059303, and entitled “Transaction Evaluation for Providing Rewards,” the disclosure of which is hereby incorporated herein by reference.

In one embodiment, the incentive, reward, or benefit provided in the loyalty program is based on the presence of correlated related transactions. For example, in one embodiment, an incentive is provided if a financial payment card is used in a reservation system to make a reservation and the financial payment card is subsequently used to pay for the reserved good or service. Further details and examples of one embodiment are provided in U.S. patent application Ser. No. 11/945,907, filed Nov. 27, 2007, assigned U.S. Pat. App. Pub. No. 2008/0071587, and entitled “Incentive Wireless Communication Reservation,” the disclosure of which is hereby incorporated herein by reference.

In one embodiment, the transaction handler (103) provides centralized loyalty program management, reporting and membership services. In one embodiment, membership data is downloaded from the transaction handler (103) to acceptance point devices, such as the transaction terminal (105). In one embodiment, loyalty transactions are reported from the acceptance point devices to the transaction handler (103); and the data indicating the loyalty points, rewards, benefits, etc. are stored on the account identification device (141). Further details and examples of one embodiment are provided in U.S. patent application Ser. No. 10/401,504, filed Mar. 27, 2003, assigned U.S. Pat. App. Pub. No. 2004/0054581, and entitled “Network Centric Loyalty System,” the disclosure of which is hereby incorporated herein by reference.

In one embodiment, the portal (143) of the transaction handler (103) is used to manage reward or loyalty programs for entities such as issuers, merchants, etc. The cardholders, such as the user (101), are rewarded with offers/benefits from merchants. The portal (143) and/or the transaction handler (103) track the transaction records for the merchants for the reward or loyalty programs. Further details and examples of one embodiment are provided in U.S. patent application Ser. No. 11/688,423, filed Mar. 20, 2007, assigned U.S. Pat. App. Pub. No. 2008/0195473, and entitled “Reward Program Manager,” the disclosure of which is hereby incorporated herein by reference.

In one embodiment, a loyalty program includes multiple entities providing access to detailed transaction data, which allows the flexibility for the customization of the loyalty program. For example, issuers or merchants may sponsor the loyalty program to provide rewards; and the portal (143) and/or the transaction handler (103) stores the loyalty currency in the data warehouse (149). Further details and examples of one embodiment are provided in U.S. patent application Ser. No. 12/177,530, filed Jul. 22, 2008, assigned U.S. Pat. App. Pub. No. 2009/0030793, and entitled “Multi-Vender Multi-Loyalty Currency Program,” the disclosure of which is hereby incorporated herein by reference.

In one embodiment, an incentive program is created on the portal (143) of the transaction handler (103). The portal (143) collects offers from a plurality of merchants and stores the offers in the data warehouse (149). The offers may have associated criteria for their distributions. The portal (143) and/or the transaction handler (103) may recommend offers based on the transaction data (109). In one embodiment, the transaction handler (103) automatically applies the benefits of the offers during the processing of the transactions when the transactions satisfy the conditions associated with the offers. In one embodiment, the transaction handler (103) communicates with transaction terminals (105) to set up, customize, and/or update offers based on market focus, product categories, service categories, targeted consumer demographics, etc. Further details and examples of one embodiment are provided in U.S. patent application Ser. No. 12/413,097, filed Mar. 27, 2009, assigned U.S. Pat. App. Pub. No. 2010/0049620, and entitled “Merchant Device Support of an Integrated Offer Network,” the disclosure of which is hereby incorporated herein by reference.

In one embodiment, the transaction handler (103) is configured to provide offers from merchants to the user (101) via the payment system, making accessing and redeeming the offers convenient for the user (101). The offers may be triggered by and/or tailored to a previous transaction, and may be valid only for a limited period of time starting from the date of the previous transaction. If the transaction handler (103) determines that a subsequent transaction processed by the transaction handler (103) meets the conditions for the redemption of an offer, the transaction handler (103) may credit the consumer account (146) for the redemption of the offer and/or provide a notification message to the user (101). Further details and examples of one embodiment are provided in U.S. patent application Ser. No. 12/566,350, filed Sep. 24, 2009, assigned U.S. Pat. App. Pub. No. 2010/0114686, and entitled “Real-Time Statement Credits and Notifications,” the disclosure of which is hereby incorporated herein by reference.

Details on loyalty programs in one embodiment are provided in U.S. patent application Ser. No. 12/896,632, filed Oct. 1, 2010, assigned U.S. Pat. App. Pub. No. 2011/0087530, and entitled “Systems and Methods to Provide Loyalty Programs,” the disclosure of which is hereby incorporated herein by reference.

### SKU

In one embodiment, merchants generate stock-keeping unit (SKU) or other specific information that identifies the particular goods and services purchased by the user (101) or customer. The SKU information may be provided to the operator of the transaction handler (103) that processed the purchases. The operator of the transaction handler (103) may store the SKU information as part of transaction data (109), and reflect the SKU information for a particular transaction in a transaction profile (127 or 131) associated with the person involved in the transaction.

When a user (101) shops at a traditional retail store or browses a website of an online merchant, an SKU-level profile associated specifically with the user (101) may be provided to select an advertisement appropriately targeted to the user (101) (e.g., via mobile phones, POS terminals, web browsers, etc.). The SKU-level profile for the user (101) may include an identification of the goods and services historically purchased by the user (101). In addition, the SKU-level profile for the user (101) may identify goods and services that the user (101) may purchase in the future. The identification may be based on historical purchases reflected in SKU-level profiles of other individuals or groups that are determined to be similar to the user (101). Accordingly, the return on investment for advertisers and merchants can be greatly improved.

In one embodiment, the user specific profile (131) is an aggregated spending profile (341) that is generated using the SKU-level information. For example, in one embodiment, the factor values (344) correspond to factor definitions (331) that are generated based on aggregating spending in different categories of products and/or services. A typical merchant offers products and/or services in many different categories.

In one embodiment, the SKU level purchase details are requested from the merchants or retailers via authorization responses, when the account (146) of the user (101) is enrolled in a program that allows the transaction handler (103) (and/or the issuer processor (145)) to collect the purchase details. Based on the SKU information and perhaps other transaction data, the profile generator (121) may create an SKU-level transaction profile for the user (101). In one embodiment, based on the SKU information associated with the transactions for each person entering into transactions with the operator of the transaction handler (103), the profile generator (121) may create an SKU-level transaction profile for each person.

Details on SKU-level profile in one embodiment are provided in U.S. patent application Ser. No. 12/899,144, filed Oct. 6, 2010, assigned U.S. Pat. App. Pub. No. 2011/0093335, and entitled “Systems and Methods for Advertising Services Based on an SKU-Level Profile,” the disclosure of which is hereby incorporated herein by reference.

### Real-Time Messages

In one embodiment, the transaction handler (103) is configured to cooperate with the media controller (115) to facilitate real-time interaction with the user (101) when the payment of the user (101) is being processed by the transaction handler (103). The real-time interaction provides the opportunity to impact the user experience during the purchase (e.g., at the time of card swipe), through delivering messages in real-time to a point of interaction (107), such as a mobile phone, a personal digital assistant, a portable computer, etc. The real-time message can be delivered via short message service (SMS), email, instant messaging, or other communications protocols.

In one embodiment, the real-time message is provided without requiring modifications to existing systems used by the merchants and/or issuers.

FIG. 9 shows a system to provide real-time messages according to one embodiment. In FIG. 9, the transaction handler (103) (or a separate computing system coupled with the transaction handler (103)) is to detect the occurrence of certain transactions of interest during the processing of the authorization requests received from the transaction terminal (105); a message broker (201) is to identify a relevant message for the user (101) associated with the corresponding authorization request; and the media controller (115) is to provide the message to the user (101) at the point of interaction (107) via a communication channel separate from the channel used by the transaction handler (103) to respond to the corresponding authorization request submitted from the transaction terminal (105).

In one embodiment, the media controller (115) is to provide the message to the point of interaction (107) in parallel with the transaction handler (103) providing the response to the authorization request.

In one embodiment, the point of interaction (107) receives the message from the media controller (115) in real-time with the transaction handler (103) processing the authorization request. In one embodiment, the message is to arrive at the point of interaction (107) in the context of the response provided from the transaction handler (103) to the transaction terminal (105). For example, the message is to arrive at the point of interaction (107) substantially at the same time as the response to the authorization request arrives at the transaction terminal, or with a delay not long enough to cause the user (101) to have the impression that the message is in response to an action other that the payment transaction. For example, the message is to arrive at the point of interaction (107) prior to the user (101) completing the transaction and leaving the transaction terminal (105), or prior to the user (101) leaving the retail location of the merchant operating the transaction terminal (105).

In FIG. 9, the system includes a portal (143) to provide services to merchants and/or the user (101).

For example, in one embodiment, the portal (143) allows the user (101) to register the communication reference (205) in association with the account data (111), such as the account information (142) of the consumer account (146); and the media controller (115) is to use the communication reference (205) to deliver the message to the point of interaction (107). Examples of the communication reference (205) includes a mobile phone number, an email address, a user identifier of an instant messaging system, an IP address, etc.

In one embodiment, the portal (143) allows merchants and/or other parties to define rules (203) to provide offers (186) as real-time responses to authorization requests; and based on the offer rules (203), the message broker (201) is to generate, or instruct the media controller to generate, the real-time message to provide the offers (186) to the user (101). For example, the offer (186) may include a discount, an incentive, a reward, a rebate, a gift, or other benefit, which can be redeemed upon the satisfaction of certain conditions required by the offer rules (203). In one embodiment, based on the offer rules (203) the message broker (201) configures a message by selecting the appropriate message template from (an) existing message(s) template(s), and inserts any relevant data (e.g., the communication reference (205)) into the selected template, then passes the configured message to the media controller (115), which delivers the message to the point of interaction (107). In one embodiment, the message broker (201) (or a subsystem) is used to manage message templates along with the rules for selecting the appropriate message template from among several potential choices.

In one embodiment, the offer rules (203) include offer details, targeting rules, advertisement campaign details, profile mapping, creative mapping, qualification rules, award/notify/fulfillment rules, approvals, etc. Creative elements for offers include text, images, channels, approvals, etc.

In one embodiment, when the offer rules (203) are activated by the merchant or advertiser via the portal (143), the message broker (201) is to generate trigger records (207) for the transaction handler (103). The transaction handler (103) is to monitor the incoming authorization requests to identify requests that satisfy the conditions specified in the trigger records (207) during the process of the authorization requests, and to provide the information about the identified requests to the message broker (201) for the transmission of an appropriate real-time message in accordance with the offer rules (203).

In one embodiment, the generation of the trigger records (207) for the transaction handler (103) is in real-time with the merchant or advertiser activating the offer rules (203). Thus, the offer rules (203) can be activated and used for the detection of the new authorization requests in real-time, while the transaction handler (103) continues to process the incoming authorization requests.

In one embodiment, the portal (143) provides information about the spending behaviors reflected in the transaction data (109) to assist the merchants or advertisers to target offers or advertisements. For example, in one embodiment, the portal (143) allows merchants to target the offers (186) based on transaction profiles (127). For example, the offer rules (203) are partially based on the values in a transaction profile (127), such as an aggregated spending profile (341). In one embodiment, the offer rules (203) are partially based on the information about the last purchase of the user (101) from the merchant operating the transaction terminal (105) (or another merchant), and/or the information about the location of the user (101), such as the location determined based on the location of the transaction terminal (105) and/or the location of the merchant operating the transaction terminal (105).

In one embodiment, the portal (143) provides transaction based statistics, such as merchant benchmarking statistics, industry/market segmentation, etc., to assist merchants and advertisers to identify customers.

Thus, the real-time messages can be used to influence customer behaviors while the customers are in the purchase mode.

In one embodiment, the benefit of the offers (186) can be redeemed via the transaction handler (103). The redemption of the offer (186) may or may not require the purchase details (e.g., SKU level purchase details). Details in one embodiment about redeeming offers (186) via the transaction handler (103) are provided in Prov. U.S. Pat. App. Ser. No. 61/347,797, filed May 24, 2010 and entitled “Systems and Methods for Redemption of Offers,” the disclosure of which is hereby incorporated herein by reference.

In one embodiment, when the authorization request for a purchase indicates that the purchase qualifies the offer (186) for redemption if the purchase corresponding to the authorization request is completed, the message broker (201) is to construct a message and use the media controller (115) to deliver the message in real-time with the processing of the authorization request to the point of interaction (107). The message informs the user (101) that when the purchase is completed, the transaction handler (103) and/or the issuer processor (145) is to provide the benefit of the offer (186) to the user (101) via statement credit or some other settlement value, for example points in a registered loyalty program, or credit at the point of sale using a digital coupon delivered to the purchaser via cell phone.

In one embodiment, the settlement of the payment transaction corresponding to the authorization request does not occur in real-time with the processing of the authorization request. For example, the merchant may submit the complete purchases for settlement at the end of the day, or in accordance with a predetermined schedule. The settlement may occur one or more days after the processing of the authorization request.

In one embodiment, when transactions are settled, the settled transactions are matched to the authorization requests to identify offers (186) that are redeemable in view of the settlement. When the offer (186) is confirmed to be redeemable based on a record of successful settlement, the message broker (201) is to use the media controller (115) to provide a message to the point of interaction (107) of the user (101), such as the mobile phone of the user (101). In one embodiment, the message is to inform the user (101) of the benefit to be provided as statement credits and/or to provide additional offers. In one embodiment, the message to confirm the statement credits is transmitted in real-time with the completion of the transaction settlement.

In one embodiment, the message broker (201) is to determine the identity of the merchant based on the information included in the authorization request transmitted from the transaction terminal (105) to the transaction handler (103). In one embodiment, the identity of the merchant is normalized to allow the application of the offer rules (203) that are merchant specific.

In one embodiment, the portal (143) is to provide data insight to merchants and/or advertisers. For example, the portal (143) can provide the transaction profile (127) of the user (101), audience segmentation information, etc.

In one embodiment, the portal (143) is to allow the merchants and/or advertisers to define and manage offers for their creation, fulfillment and/or delivery in messages.

In one embodiment, the portal (143) allows the merchants and/or advertisers to test, run and/or monitor the offers (186) for their creation, fulfillment and/or delivery in messages.

In one embodiment, the portal (143) is to provide reports and analytics regarding the offers (186).

In one embodiment, the portal (143) provides operation facilities, such as onboarding, contact management, certification, file management, workflow, etc. to assist the merchants and/or advertisers to complete the tasks related to the offers (186).

In one embodiment, the portal (143) allows the user (101) to opt in or opt out of the real-time message delivery service.

In one embodiment, an advertiser or merchant can select an offer fulfillment method from a list of options, such as statement credits, points, gift cards, e-certificates, third party fulfillment, etc.

In one embodiment, the merchant or advertiser is to use the “off the rack” transaction profiles (127) available in the data warehouse (149). In one embodiment, the merchant or advertiser can further edit parameters to customize the generation of the transaction profiles (127) and/or develop custom transaction profiles from scratch using the portal (143).

In one embodiment, the portal (143) provides a visualization tool to allow the user to see clusters of data based on GeoCodes, proximity, transaction volumes, spending patterns, zip codes, customers, stores, etc.

In one embodiment, the portal (143) allows the merchant or advertiser to define cells for targeting the customers in the cells based on date/time, profile attributes, map to offer/channel/creative, condition testing, etc.

In one embodiment, the portal (143) allows the merchant or advertiser to monitor the system health, such as the condition of servers, files received or sent, errors, status, etc., the throughput by date or range, by program, by campaign, or by global view, and aspects of current programs/offers/campaigns, such as offer details, package audit reports, etc. In one embodiment, reporting includes analytics and metrics, such as lift, conversion, category differentials (e.g., spending patterns, transaction volumes, peer groups), and reporting by program, campaign, cell, GeoCode, proximity, ad-hoc, auditing, etc.

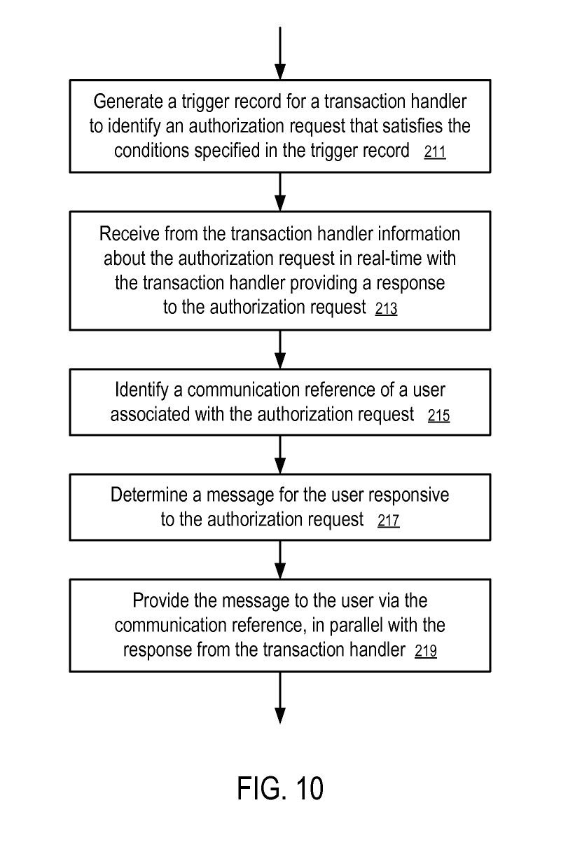

FIG. 10 shows a method to provide real-time messages according to one embodiment. In FIG. 10, a computing apparatus is to generate (211) a trigger record (207) for a transaction handler (103) to identify an authorization request that satisfies the conditions specified in the trigger record (207), receive (213) from the transaction handler (103) information about the authorization request in real-time with the transaction handler (103) providing a response to the authorization request to a transaction terminal (105), identify (215) a communication reference (205) of a user (101) associated with the authorization request, determine (217) a message for the user (101) responsive to the authorization request, and provide (219) the message to the user (101) at a point of interaction (107) via the communication reference (205), in parallel with the response from the transaction handler (103) to the transaction terminal (105).

In one embodiment, the computing apparatus includes at least one of: a transaction handler, a message broker (201), a media controller (115), a portal (143) and a data warehouse.

### Rule Formation and Management

In one embodiment, the portal (143) provides a user interface to allow a merchant to define aspects of the offers (186) and offer rules (203), such as to whom the offers (186) are to be extended, when and what messages are to be delivered, the fulfillment conditions for the offers (186), etc.

Since the combination of offers, targeting criteria and fulfillment terms can be complex and dynamic, describing the life cycle of complex offers in a form that can be automated is a challenge.

In one embodiment, a system is provided to allow complex offers to be described in a format that is both human understandable and can be automated. The offer rules are formulated and managed in a way such that changes to the offer rules can be applied dynamically during the offer campaign without losing track of the accomplishments a targeted consumer has already successfully achieved.

In one embodiment, the portal (143) allows the offers to be described as a set of stand alone events that can be consumed by a rule engine (209). The events are linked via prerequisite conditions to formulate the fulfillment requirements. This technique allows offers to be managed and altered while an offer campaign, formulated based on real-time monitoring of transactions and user activities, is live in execution.

In one embodiment, the data warehouse (149) is configured to store data indicating the completion status of each of the events for each of the users. Thus, modifications and adjustments can be made to the specifications of the offer campaign in run time during the execution of the offer campaign.

In one embodiment, stand alone events are the basic building blocks used to describe offer campaigns. One or more events can be strung together via prerequisite conditions to describe the requirements for transaction/user action tracking, message delivery, offer qualification, offer fulfillment, etc. in the life cycle of an offer campaign.

In one embodiment, when existing event types are not capable of describing a desired event, a custom type of events can be created in a reusable manner to add to the system. The custom event can be subsequently provided as available event types. Thus, the system can be dynamically extended to accommodate new requirements, while running existing real-time offer campaigns.

In one embodiment, the building-block events can be strung together to form a flow or network of events, via prerequisite conditions that refer to prior occurrences of events. The flow or network events define the offer rules for an offer campaign, which can be altered during the execution of the offer campaign to allow on-the-fly management.

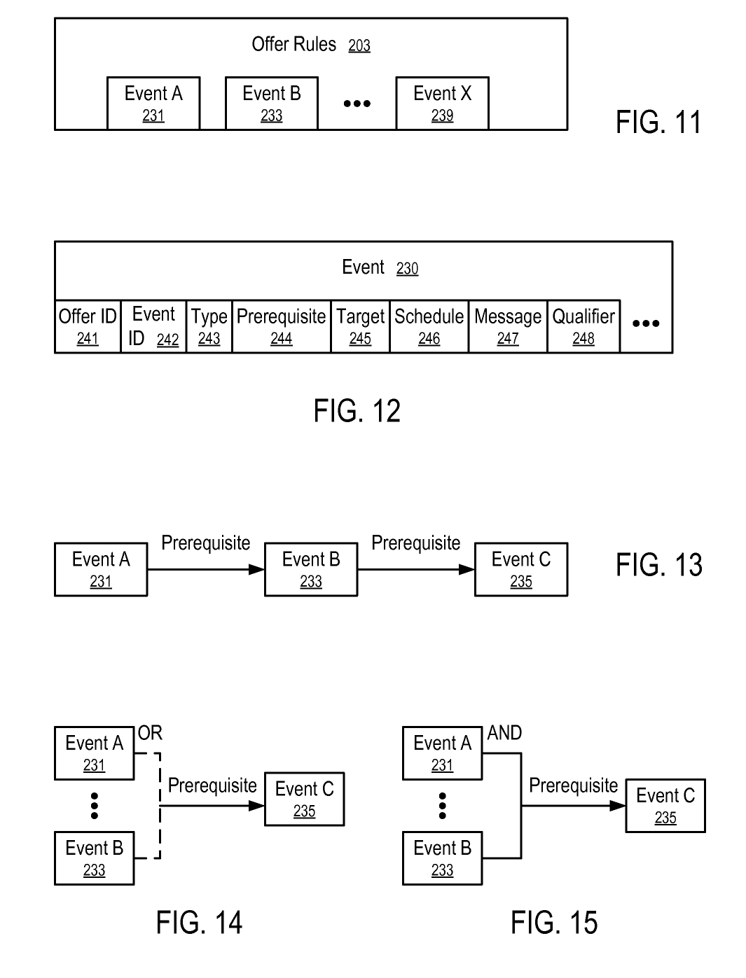

FIG. 11 shows a structure to specify offer rules according to one embodiment. In FIG. 11, the offer rules (203) for one offer campaign are specified via a set of events (231, 233, . . . , 239). In one embodiment, each of the events (231, 233, . . . , 239) is an atomic, independent event in that the entire set of actions or operations specified for the event, if any, is to be performed in response to the detection of an occurrence of the event, independently of the occurrences of other events.

FIG. 12 shows a structure to specify an event according to one embodiment. In one embodiment, an event (230) includes a plurality of fields, such as offer ID (241), event ID (242), type (243), prerequisite (244), target (245), schedule (246), message (247), qualifier (248), etc. In one embodiment, an administrator is to specify the content of the fields via keywords and/or values readable and understandable to a human (e.g., a salesperson); and the rule engine (209) is programmed to process the keywords and/or values to generate corresponding records to direct the operations of the system (e.g., as illustrated in FIG. 9). In one embodiment, the content describing the fields of a set of events are provided to the system via a spreadsheet. In another embodiment, the portal (143) provides a graphical user interface to guide the administrator in specifying the content of the fields and making modifications during run time.

In one embodiment, the offer ID (241) is used to identify a particular offer campaign to which the event (230) belongs. The set of events having the same offer ID (241) forms the rules for the offer campaign.

In one embodiment, the event ID (242) is an identifier of the event (230). Prerequisite conditions are specified via referring to the identifiers of the events.

In one embodiment, the type (243) is to specify the type of the event based on a plurality of predefined types of events. For example, in one embodiment, the event types include a type of events corresponding to transactions processed at the transaction handler (103), a type of events corresponding to the completion of one or more events identified by their identifiers, a type of events corresponding to the completion of a user action with the portal (143) (e.g., enrollment), a type of events corresponding to the arrival of a time window, a type of events corresponding to the performance of a scheduled action, etc. Additional event types can be added to the system to extend the capability of the system in defining new offer campaigns or modifying existing offer campaigns, during the execution of previously defined offer campaigns, without impairing the execution of offer campaigns previously defined without using the newly added event types.

In one embodiment, the prerequisite (244) is to identify one or more events by their identifiers to indicate a prerequisite condition. A user is to complete the events according to the prerequisite condition prior to completing the event (230). The event (230) is not detected and/or processed for the user, until the prerequisite condition is satisfied. The reference to the one or more events in the field of prerequisite (244) links the event (230) to the corresponding one or more events that are referenced in the field of prerequisite (244). The collective data in the prerequisite fields of the events of an offer campaign form a string, flow, or network of events that represent the operation requirements and fulfillment conditions for the offer campaign.

In one embodiment, the target (245) is to identify a set of users to which the event (230) is applicable. For example, in one embodiment, the set of users may be identified via enrollment status in a program and/or other criteria, such as values (e.g., 342-347) of aggregated spending profile (341), account data (111), etc.

In one embodiment, the schedule (246) is to identify a time window during which the event (230) is applicable. In one embodiment, the time window includes a starting date and time and an ending date and time. The time window may be specified via a calendar, or relative to another identified time instance.

In one embodiment, the message (247) is to identify a message to be transmitted to the corresponding user, when an occurrence of the event (230) is detected for the user. In one embodiment, the message (247) is to further identify a communication method to transmit the message, such as via SMS, email, instant message, receipt, transaction terminal, statement, etc. In one embodiment, transmitting a message (247) is optional in response to an occurrence of the event (230). The administrator may choose to specify no message for the event (230).

In one embodiment, the qualifier (248) is to provide additional parameters related to the event. For example, in one embodiment, a parameter can be used to request the transmission of the message (247) at a specific time of day after the occurrence of the event (230) satisfying the prerequisite (244) is detected. For example, in one embodiment, a parameter can be used to request a delay of a specific time period, after the occurrence of the event (230) satisfying the prerequisite (244) is detected, before transmission of the message (247). For example, in one embodiment, a parameter is used to limit the detection of a transaction to certain merchants, or merchant categories. For example, in one embodiment, a parameter is used for the detection of a transaction not with certain merchants, or merchant categories. For example, in one embodiment, a parameter is used for the detection of a transaction occurring within a specific time period of the day. For example, in one embodiment, a parameter is used to request the verification of the settlement of a transaction.

In one embodiment, the event (230) contains a field for specifying operations other than transmitting a message. For example, in response to one event (230), a field is to specify an amount of statement credits to be provided to the corresponding user.

In one embodiment, the prerequisite (244) can be used to link the event (230) to one or more events in one of a plurality of formats.

In one embodiment, each of the events (e.g., 231, 233, . . . , 239) corresponds to the detection of one occurrence of one event and optionally specifies one operation to be performed by the system. For the convenience of administrators in specifying the events, a user interface may allow an administrator to specify the detection of more than one occurrence of one event and/or more than one operation to be performed by the system. The rule engine (209) is to break down such a complex event into simple events where each event corresponds to the detection of one occurrence of one event and optionally specifies one operation to be performed by the system during the modification of the rules. In one embodiment, the rule engine (209) may automatically combine multiple simple events into a complex event for an administrator viewing and/or modifying the rules. When the administrator is to modify a complex event, the rule engine (209) is to break down the event into simple events. Thus, the offer rules (203) can be specified, viewed and/or modified as a hierarchy of events, where each complex event is defined by less complex events or simple events.

FIGS. 13-15 illustrate examples to link events according to some embodiments. In FIG. 13, event B (233) specifies event A (231) as the prerequisite condition, which indicates that event B (233) cannot occur for a particular user before an occurrence of event A (231) is detected for the particular user. Thus, the occurrence of event B (233) is not detected or processed for the particular user before the detection of the occurrence of event A (231) for the particular user.

Similarly, in FIG. 13, event C (235) specifies event B (231) as the prerequisite condition. Thus, the occurrence of event C (235) is not detected or processed for the particular user before the detection of the occurrence of event B (233) for the particular user.

In FIG. 14, event C (235) specifies, as its prerequisite condition, a set of events (e.g., 231, . . . , 233) that are connected via an “OR” relationship. Thus, the occurrence of event C (235) is not detected or processed for the particular user before the detection of the occurrence of at least one event in the set (e.g., 231, . . . , 233) for the particular user. In one embodiment, a qualifier can be used to specify a number such that the occurrence of event C (235) is not detected or processed for the particular user before the detection of the occurrence of at least the specified number of events in the set (e.g., 231, . . . , 233) for the particular user.

In FIG. 15, event C (235) specifies, as its prerequisite condition, a set of events (e.g., 231, . . . , 233) that are connected via an “AND” relationship. Thus, the occurrence of event C (235) is not detected or processed for the particular user before the detection of the occurrence of all events in the set (e.g., 231, . . . , 233) for the particular user.

In one embodiment, a particular event can be referred to in the prerequisite conditions specified in one or more subsequent events.

In general, the prerequisite conditions of the events link the events into a flow or network of events, scheduled for detection based on the activities in the transaction handler (103), the portal (143), and/or other components, such as the message broker (201) and media controller (115).

In one embodiment, the data warehouse (149) is to store data for a particular user to indicate the completion status of the events. For example, in one embodiment, the data warehouse (149) is to store a list of events that the particular user has completed. The events not on the list are events that have not yet been completed by the particular user. Different users may have a different set of completed events and thus different progress in the flow or network of events. The completion status data allow an administrator to dynamically change the flow or network of events in real-time, while the detection and messaging activities are in progress for a set of users and the different achievements of the users in the flow or network of events are preserved.

In one embodiment, the messages to be transmitted in response to detection of events are configured to avoid mentioning events that have not yet been completed. In one embodiment, the messages to be transmitted in response to detection of events are configured to avoid mentioning events other than those referred to in the prerequisite conditions of the corresponding detected events. Thus, the administrator can change the flow or network of events while still maintaining consistency with the messages previously transmitted to the users.

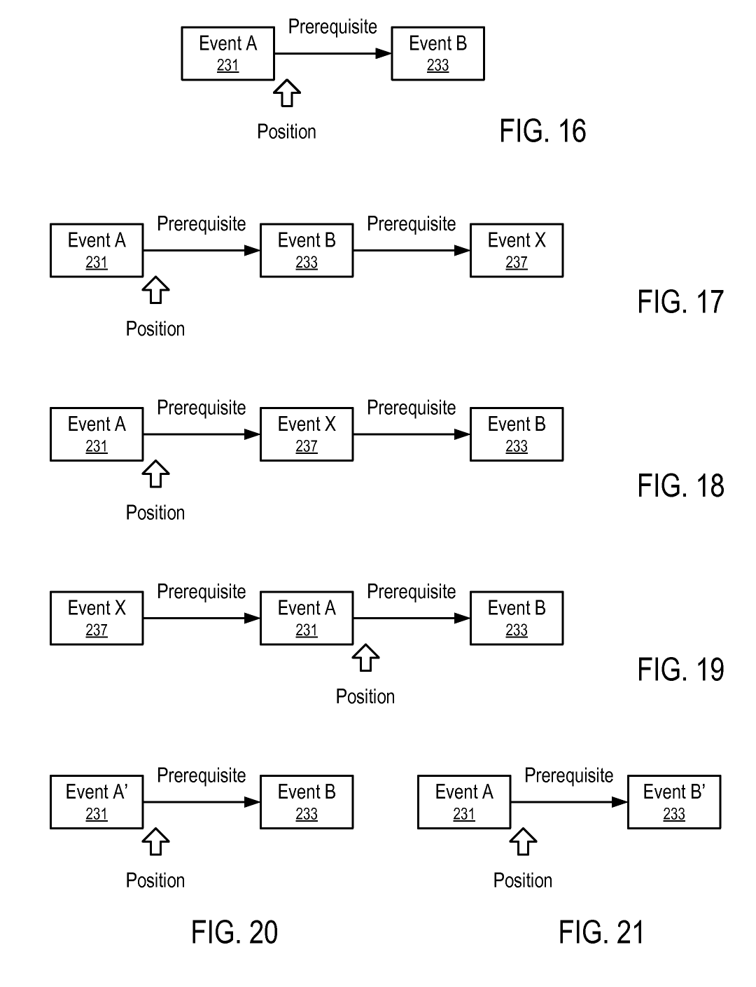

In one embodiment, the data warehouse (149) is to store data to show the current position of the user (101) in the flow or network of events. FIG. 16 illustrates a tracked position of a user (e.g., 101) in accordance with a set of offer rules according to one embodiment. In one embodiment, the stored data indicates that the progress of the user (101) in the flow or network is at the position between event A (231) and event B (233), after the user (101) has completed event A (231) but not yet completed event B (233).

In one embodiment, FIG. 16 illustrates a segment of a flow or network. A user (e.g., 101) may have multiple positions in different segments of the flow or network.

In general, different users (e.g., 101) have different positions in the flow or network of events.

FIGS. 17-21 illustrate examples of modifying an offer rule according to some embodiments. In FIG. 17, new event X (237) is added after event B (233). In FIG. 18, new event X (237) is inserted between event A (231) and event B (233). In both FIGS. 17 and 18, new event X (237) is to be detected for the user (101), since the modification is made in the flow or network of events after the position of the user (101); and the corresponding actions specified for new event X (237) are to be performed in response to the detection of an occurrence of new event X (237).

In FIG. 19, new event X (237) is added before event A (233), which is before the position of the user (101); thus, the addition of new event X (237) has no effect on the user (101); and there is no need to detect new event X (237) for the user (101).

In FIG. 20, existing event A (231) is modified, which is before the position of the user (101); thus, the modification to the specification of the event A (231) has no effect on the user (101).

In FIG. 21, existing event B (233) is modified, which is after the position of the user (101); thus, the modification to the specification of the event B (233) is applicable to the user (101). In FIG. 21, the detection of event B (233) is performed based on the modified specification of event B (233); and operations performed in response to the detection of an occurrence of event B (233) is in accordance with the modified specification of event B (233).

In one embodiment, the administrator may change the prerequisite condition of an event. For example, if the prerequisite condition of event A (231) located before the position of the user (101) is changed, the change has no effect on the user (101). For example, if the prerequisite condition of event B (231) located after the position of the user (101) is changed, the detection of the event B (231) is to be in accordance with the modified prerequisite condition.

In one embodiment, the administrator may delete an event from the flow or network of events. Based on the positions of the users (e.g., 101), the system automatically applies the change to the applicable users (e.g., 101). In one embodiment, when an event is deleted from the flow or network of events, the system is to continue tracking the completion status of the event, such that if the administrator chooses to reconnect the event back into the flow or network of events, the status information of the event can be used without loss of information.

For example, an initial design of an offer campaign is configured to send an offer notice to a person after 5 purchases. During the offer campaign, person A makes 2 purchases; and person B makes 4 purchases. At this point, the administrators of the offer campaign may desire to change from the 5-purchase requirement to a 3-purchase requirement (or a 6-purchase requirement). In one embodiment, the portal (143) provides a way to allow the administrators formulate and/or adjust the rules while honoring customers' accomplishments. For example, in one embodiment, the administrators can provide input to the portal (143) to specify the rule change from the 5-purchase requirement to the 3-purchase requirement in a way such that person A would now only have one more purchase to make to satisfy the requirement; and person B would now satisfy the requirement.

For example, the 5-purchase requirement is specified via a string of 5 individual events, each corresponding to one purchase. The 5 events are connected in a string via prerequisite condition. When the administrator removes the last two events from the string to change the 5-purchase requirement to a 3-purchase requirement, a user who has already made 2 purchases has one more purchase to make to satisfy the requirement; and a user who has already made 4 purchases has now satisfied the purchase requirement.

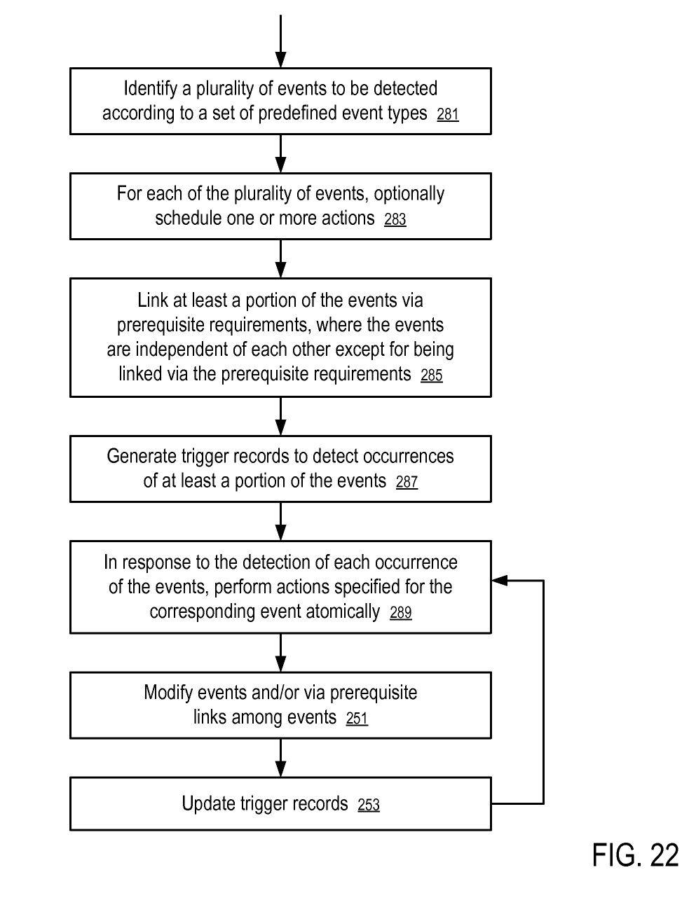

FIG. 22 shows a method to formulate and process offer rules according to one embodiment. In FIG. 22, a computing apparatus is configured to receive data identifying (281) a plurality of events to be detected according to a set of predefined event types, and for each of the plurality of events, optionally schedule (283) one or more actions according to the received data. In one embodiment, the received data is to link (285) at least a portion of the events via prerequisite requirements, where the events are independent of each other except for being linked via the prerequisite requirements.

In FIG. 22, the computing apparatus is further configured to generate (287) trigger records to detect occurrences of at least a portion of the events, and perform (289) actions specified for the corresponding event atomically in response to the detection of each occurrence of the events.

In FIG. 22, the computing apparatus is further configured to receive data modifying (251) events and/or via prerequisite links among events, update (253) trigger records according to the modifications, and detect occurrences of the events using the updated trigger records.

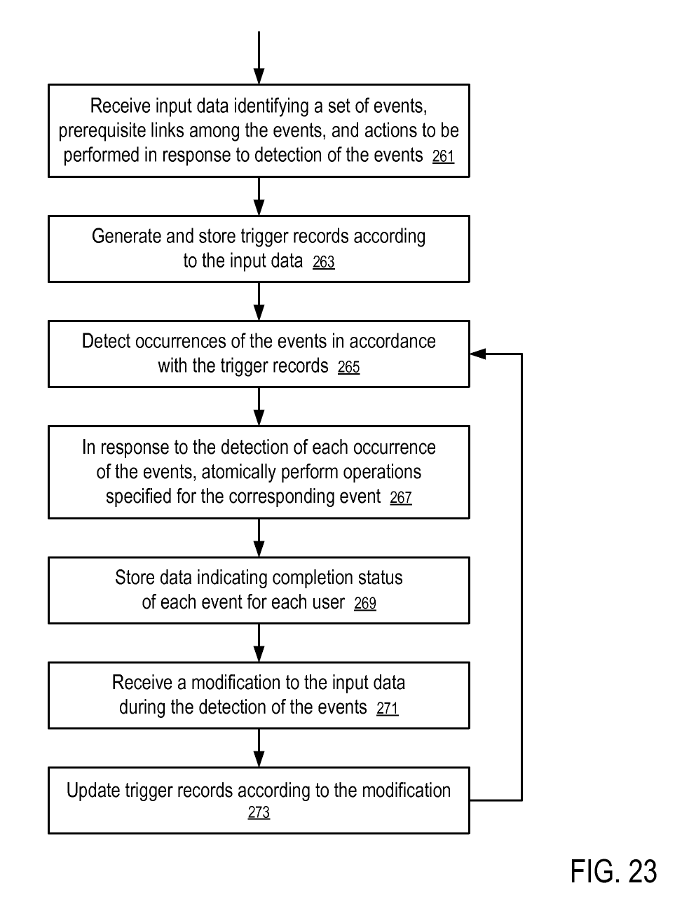

FIG. 23 shows a method to modify offer rules according to one embodiment. In FIG. 23, the computing apparatus is to receive (261) input data identifying a set of events, prerequisite links among the events, and actions to be performed in response to detection of the events. The computing apparatus is to generate and store (263) trigger records according to the input data, and detect (265) occurrences of the events. In response to the detection of each occurrence of the events, the computing apparatus is to atomically perform (267) operations specified for the corresponding event.

In FIG. 23, the computing apparatus is to store (269) data indicating completion status of each event for each user.

During the detection of the events according to the trigger records, the computing apparatus is to receive (271) a modification to the input data and update (273) trigger records according to the modification. Once the trigger records are updated, the computing apparatus is to continue the detection (265) of the occurrences of the events in accordance with the trigger records.

In one embodiment, the computing apparatus includes at least one of: a data warehouse (149), a transaction handler (103), a portal (143), a message broker (201), a media controller (115) and a rule engine (209), as illustrated in FIG. 9.

In one embodiment, an administrator is to use a spreadsheet to specify the fields (e.g., 241-248) via keywords and/or key-value pairs for the events (231, 233, . . . , 239) that define the offer rules (203) and submit the spreadsheet to the portal (143). Based on the spreadsheet, the portal (143) is to generate an XML file specifying the offer rules (203) for the rule engine (209).

In one embodiment, the portal (143) is configured to export the offer rules (203) for an offer campaign being run by the rule engine (209) to a spreadsheet for viewing, confirmation, and/or modification by the administrator.

In one embodiment, the portal (143) provides a graphical user interface to show the offer rules (203) and/or to guide the administrator in creating and/or modifying the offer rules (203).

Using the description system for the offer rules (203), described based on connecting simple events that are processed atomically, the computing apparatus allows an ordinary person to program a complex offer campaign without having the expertise of a typical software programmer. Further, in combination with storing the data indicating the completion status of the events for each of the users, the system allows run-time dynamic modifications to the rules without requiring the expertise of a typical software programmer.

### Multiple Accounts

In one embodiment, a computing apparatus is configured to allow a cardholder having multiple account identification devices, corresponding to different consumer accounts issued by the same issuer, or different issuers, to use different account identification devices to fulfill different requirements of the offer campaign. Thus, the offer campaign can be collectively driven by the set of registered consumer accounts of the user, as if the set of registered consumer accounts were a single consumer account.

For example, in one embodiment, an offer campaign may require a user to make two purchases to get a statement credit; and the user may register two or more consumer accounts, use a first consumer account selected from the registered accounts to make the first required purchase, and use a second consumer account to make the second required purchase to get the statement credit provided by the offer campaign.

In one embodiment, the computing apparatus is configured to store data identifying a group of accounts of a user. The user may identify more than one consumer account for the account group for participation in offer campaigns. The consumer accounts registered in the account group may be issued by the same issuer, or different issuers. The computing apparatus is configured to track the milestones achieved by the user based on the collective transactions in the account group, instead of separated for individual accounts. Thus, the transactions in different accounts of the user can drive the activities of the offer campaign for the user, as if the transactions were in the same consumer account. The milestones are not segregated according to the individual accounts in the account group of the user.

In one embodiment, the offer rules of an offer are configured to instruct the computing apparatus to interact with the user in response to the transactions in the account group of the user. For example, in response to a first transaction that is made in a first consumer account in the account group and that satisfies one or more conditions of the offer rules of an offer campaign, the computing apparatus is configured to enroll the user in the offer campaign; in response to a second transaction that is made in a second consumer account in the account group and that satisfies one or more conditions of the offer rules of the offer campaign in which the user is enrolled based on the first transaction in the first consumer account, the computing apparatus is configured to transmit a message to the user, indicating that the user is entitled to the benefit of a discount (e.g., 10% off) for the next transaction in the offer campaign; and subsequently, in response to a third transaction that is made in a third consumer account in the account group and that satisfies one or more conditions of the offer rules of the offer campaign, the computing apparatus is configured to provide the discount to the user.

In one embodiment, the offer rules of the offer campaign do not require the user to use a specific account in the account group to make the transaction that satisfies the requirement of the offer campaign. In one embodiment, the offer rules of the offer campaign/offer are not based on the identity of the consumer account and/or the attribute of the consumer account. Thus, any of the accounts in the account group can have a transaction that satisfies the one or more requirements to trigger an action in the offer program, such as enrolling the user, transmitting a message to the user, providing a benefit to the user, etc.

In one embodiment, at least one of the offer rules of the offer campaign is based on at least one attribute of the consumer accounts in the account group. A transaction is required to be made in a consumer account that satisfies a condition formulated based on the attributed of the consumer account. For example, the offer rule may require a transaction to be made in a consumer account issued by a particular issuer or one issuer from a particular group of issuers, in order to trigger the action in association with the transaction. For example, the offer rule may require a transaction to be made in a consumer account of a particular type, in order to trigger the action in association with the transaction. For example, the offer rule may require a transaction to be made in a consumer account having a balance, or a credit limit, over a predetermined threshold, in order to trigger the action in association with the transaction.

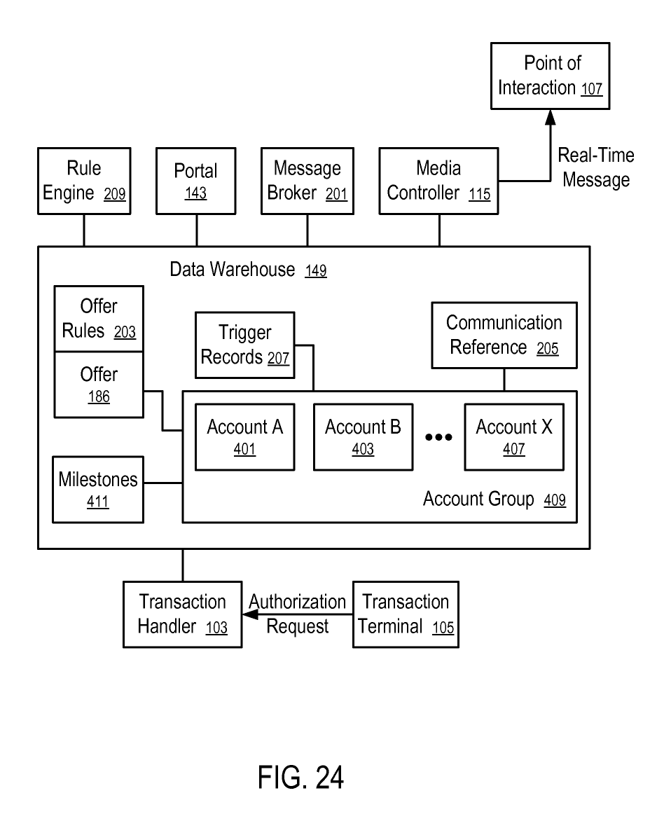

FIG. 24 shows a system to process offer rules in response to transactions in a plurality of accounts of a user according to one embodiment. In FIG. 24, the data warehouse (149) is configured to store data representing an account group (409) for a user (101). The account group (409) identifies one or more consumer accounts (e.g., 401, 402, . . . , 407) of the user (101). The consumer accounts (e.g., 401, 402, . . . , 407) may be issued by the same issuer, or different issuers. The consumer accounts (e.g., 401, 402, . . . , 407) may be of a same type, or different types (e.g., credit, debit, prepaid, etc., or preferred, gold, platinum, etc.).

In FIG. 24, the data warehouse (149) stores the offer (186) and its associated offer rules (203). In one embodiment, the offer rules (203) are specified via events (230) linked with prerequisite conditions, in a way as discussed in the section entitled “RULE FORMATION AND MANAGEMENT.”

In FIG. 24, the data warehouse (149) stores data to associate the offer (186) with the account group (409) to allow the transactions in the account group (409) to drive the actions specified in the offer rules (203) for the offer (186).

In one embodiment, the offer (186) is associated with the account group (409) of the user (101) based on an action of the user (101). For example, in one embodiment, when the transaction profile (e.g., 131 or 341) of the user (101) satisfies the requirement of the offer (186), the offer (186) is presented to the user (101) via the media controller. The offer (186) may be presented to the user (101) in response to a transaction in the account group (409) that satisfies one or more requirements of the offer (186), or in response to the user (101) visiting the portal (143). After the user (101) accepts the offer (186), the data warehouse (149) stores data to associate the offer (186) and the account group (409) of the user (101).

In one embodiment, after the user (101) provides a consent to receive certain types of offers (e.g., 186), the offer (186) is automatically associated with the account group (409) of the user (101), when the eligibility requirements of the offer (186) is satisfied by the user (101), without requiring the user (101) to provide input to explicitly accept the offer (186). When the offer (186) is associated with the account group (409) in the data warehouse (149), the message broker (201) is configured to generate a message for transmission to the communication reference (205) associated with the account group (409) of the user (101).

In FIG. 24, the rule engine (209) is configured to generate trigger records (207) to detect transactions that are made in the account group (409) and that satisfy the requirements for next actions in accordance with the offer rules (203). The data warehouse (149) stores data indicating the milestones (411) achieved in the account group (409) collectively as a whole.

In one embodiment, the milestones (411) is tracked by the current position of the account group (409) in the chain of events linked by prerequisite conditions, as illustrated in FIGS. 16-21. The current position is tracked for the account group as a whole, instead of for individual accounts in the account group. Thus, the transactions in different accounts in the account group have similar opportunities to advance the current position of the account group (409) in the offer (186) or offer campaign.

In one embodiment, each of the trigger records (207) identifies one of the accounts (e.g., 401, 403, . . . , 407) in the account group (409). The rule engine (209) is configured to generate a trigger record (207) for each of the accounts (e.g., 401, 403, . . . , 407) in the account group (409) to detect a transaction that matches the requirement(s) of a next event following the current position in the event chain of the offer (186)/offer campaign.

In one embodiment, when a next event following the current position has a requirement based on an attribute of the account (e.g., 401, 403, . . . , or 407), such as the type of the account, the issuer of the account, the balance of the account, the credit limit of the account, etc., the rule engine (209) is configured determine first accounts (e.g., 401, 403, . . . , 407) that satisfy the requirement, and generate trigger records for the first accounts, but not for the other accounts, to improve efficiency of the system in matching transactions with the trigger records.

In one embodiment, the rule engine (209) is configured to remove trigger records corresponding to the events before the current position of the account group in the event chain of the offer (186)/offer campaign, and generate trigger records corresponding to the events immediately after the current position of the account group (409) in the event chain of the offer (186)/offer campaign, as the current position of the account group (409) advances in the event chain of the offer (186)/offer campaign.

In one embodiment, the rule engine (209) is configured to generate only trigger records for events corresponding to transactions that are capable of being matched based on the transactions themselves. Trigger records are not generated for events that have unmet prerequisite conditions in the event change. Trigger records for events that have been matched, or cannot be matched, are removed by the rule engine (209), in response to the advance of the current position(s) of the account group (409) in the event chain of the offer (186)/offer campaign.

In one embodiment, an event chain is configured to have multiple subsequent events after the occurrence of a prerequisite event. The offer campaign may advance to one or more of the subsequent events, following the prerequisite event.

In one embodiment, multiple parallel subsequent events may lead to different branches or paths in the event chain of the offer (186)/offer campaign; and the milestones (411) indicate the current positions of the account group (409) on the different branches or paths.

In one embodiment, the benefit of the offer (186) is provided to the account in response to a transaction in that account which matches with the event (230) that specifies the action to provide the benefit of the offer (186). For example, when a transaction in the account (403) matches the trigger record (207) for an event (230) to provide a statement credit, the statement credit is issued to the account (403) in which the corresponding transaction occurs, although the prerequisite events (230) were satisfied by transactions in other accounts in the account group (409), such as the account (401 or 407).

In one embodiment, the benefit of the offer (186) is divided among the accounts (e.g., 401, 403, . . . , 407) in which transactions occurred to advance the account group (409) to the event that provides the benefit.

In one embodiment, the data warehouse (149) is further configured to store information about the contributions of the individual accounts (e.g., 401, 403, . . . , 407) in the offer campaign. For example, the contributions can be measured based on the transaction amounts of relevant transactions made in the respective accounts (e.g., 401, 403, . . . , 407). For example, the contributions can be measured based on the number of transactions made in the respective accounts (e.g., 401, 403, . . . , 407) to satisfy the requirements for the benefit of the offer (186). For example, the contributions can be measured based on the number of items purchased via the transactions made in the respective accounts (e.g., 401, 403, . . . , 407) to satisfy the requirements for the benefit of the offer (186). For example, the contributions can be measured based on a combination of transaction amount, number of transactions, items purchased, etc.

In one embodiment, the rule engine (209) is configured to divide the benefits of the offer (186) among the accounts (e.g., 401, 403, . . . , 407) in account group (409), based on the contributions of the individual accounts (e.g., 401, 403, . . . , 407).

In one embodiment, the rule engine (209) is configured to provide credits to the issuers of the accounts (e.g., 401, 403, . . . , 407) for offer campaign completed for the account group, based on the contributions of the individual accounts (e.g., 401, 403, . . . , 407).

In one embodiment, some of the actions specified in the events for the offer (186)/offer campaign are triggered by transactions in the account group (409); some of the actions specified in the events for the offer (186)/offer campaign are triggered by user interaction with the portal (143) (e.g., via the point of interaction (107), such as a mobile computer, a mobile phone, a personal media player, etc.).

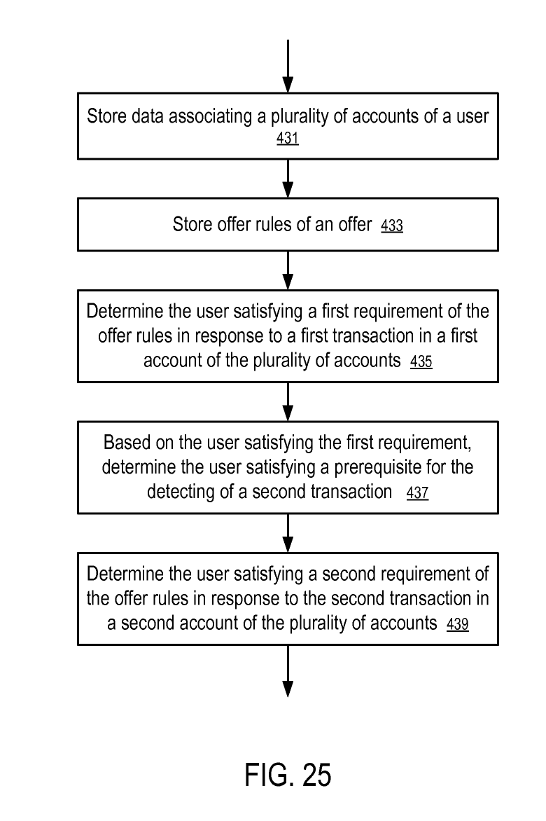

FIG. 25 shows a method to process offer rules in response to transactions in a plurality of accounts of a user according to one embodiment. In FIG. 25, a computing apparatus is configured to: store (431) data associating a plurality of accounts (e.g., 401, . . . , 407) of a user (409); store (433) offer rules (203) of an offer (186); determine (435) the user (101) satisfying a first requirement of the offer rules (203) in response to a first transaction in a first account (e.g., 401) of the plurality of accounts; determine (437), based on the user (101) satisfying the first requirement, the user (101) satisfying a prerequisite for the detecting of a second transaction, which may occur in more than one of the plurality of accounts (e.g., 401, . . . , 407); and determine (439) the user (101) satisfying a second requirement of the offer rules in response to the second transaction in a second account (e.g., 403) of the plurality of accounts (e.g., 401, . . . , 407).

In one embodiment, in response to the authorization request and/or response for the first or second transaction, the computing apparatus is configured to interact with the user (101) in real time, such as providing a message to the communication reference (205) of the user (101).

For example, the method to process the offer rules may include: storing, in the computing apparatus (e.g., in the data warehouse (149)), data associating a plurality of accounts (e.g., 401, 403, . . . , 407) of the user (101); storing, in the computing apparatus, offer rules (203) of an offer (186) associated with the accounts (401, 403, . . . , 407) of the user (101); determining, by the computing apparatus, the user satisfying a first requirement of the offer rules (186) of the offer (186) in response to a first transaction in a first account (e.g., 401) of the plurality of accounts (401, 403, . . . , 407) of the user (101); and determining, by the computing apparatus, the user (101) satisfying a second requirement of the offer rules (203) of the offer (186) based on: i) a second transaction in a second account (e.g., 403) of the user (101) that is different and separate from the first account (401), and ii) the user (101) satisfying the first requirement via the first transaction in the first account (401) of the user (101).

For example, the method may further include: transmitting a message identifying a benefit of the offer (186), in response to the first transaction in the first account (401), based on which the user satisfies the first requirement of the offer (186); and providing the benefit of the offer (186) to the user (101), in response to the second transaction in the second account (403) based on which the user satisfies the second requirement.

For example, the benefit may be sponsored by a merchant to provide discount, reward, cashback, and/or loyalty incentive to the user (101) when the requirements of the offer (186) are satisfied.

For example, the first account (401) and the second account (403) may be issued by different issuers; and the offer rules (203) are identified by the merchant without specifying account issuers for transactions to meet the first requirement and the second requirements.

For example, the first requirement is capable of being satisfied via a transaction in any of the plurality of accounts (401, 403, . . . , 407) of the user; and the second requirement is capable of being satisfied via a transaction in any of the plurality of accounts (401, 403, . . . , 407) of the user.

For example, the method may further include: tracking contributions of the plurality of accounts (401, 403, . . . , 407) to satisfying requirements of the offer rules (203) of the offer (186); and dividing a benefit of the offer (186) among the plurality of accounts (401, 403, . . . , 407) based on the contributions of the plurality of accounts (401, 403, . . . , 407).

Alternatively, the method may provide the entire benefit of the offer (186) to the second account (403) in accordance with the offer rules (203) of the offer (186), even when some of the requirements of the offer rules (203) are satisfied by transactions in other accounts (e.g., 401, and/or 407).

For example, the method may further include: tracking contributions of the plurality of accounts (401, 403, . . . , 407) to satisfying requirements of the offer rules (203) of the offer (186); and providing credits to issuers of the plurality of accounts (401, 403, . . . , 407) based on the contributions of the plurality of accounts.

For example, the offer rules (203) of the offer (186) can be specified by a merchant in terms of a set of events chained via prerequisite conditions, as illustrated in FIGS. 11-21. The requirements of different events can be satisfied by transactions in different accounts (401, 403, . . . , 407) in the account group (409) associated with the offer (186).

In one embodiment, some of the requirements of the offer rules (203) may include a condition formulated based on an attribute of an account used to make the qualifying transaction to satisfy the corresponding requirement(s).

For example, the attribute of the account may be based on an identity of an issuer of an account used to make the qualifying transaction.

Alternatively, or in combination, the account specific requirements may be formulated based on one or more of: an account type of an account used to make the corresponding qualifying transaction; an account balance of an account used to make the qualifying transaction; and a credit limit of an account used to make the qualifying transaction.

For example, the method may further include: receiving a user input to accept the offer (186); and storing data to associate the plurality of accounts (401, 403, . . . , 407) of the user (101) with the offer (186).

For example, the offer rules (203) of the offer (186) may be specified in terms of a set of required events chained via prerequisite conditions, as illustrated in FIGS. 13-21; and the method further includes: generating trigger records (207) to detect a first event in the set of events. The first event is capable of being satisfied via transactions in the plurality of accounts at the current milestone stage of the offer (186), in view of prior transactions relevant to the offer (186), independent of any other future transactions; and each of the trigger records is configured to detect a transaction in one of the plurality of accounts.

For example, the method may further include: in response to the first transaction, removing trigger records in accordance with prerequisite conditions in the offer rules, and/or adding trigger records in accordance with prerequisite conditions in the offer rules.

For example, a trigger record configured to monitor transactions in an account (e.g., 401, 403, . . . , 407) for the offer (186) but cannot be satisfied via a transaction in the corresponding account (e.g., 401, 403, . . . , 407) with or without a further qualifying transaction can be removed.

For example, after Event A (231) in FIG. 16 is detected, the trigger record for detecting Event A (231) can be removed; and the trigger record for detecting Event B (233) that requires Event A (231) as a prerequisite condition can be generated; and the trigger record for detecting Event B (233) is not generated until the prerequisite condition of Event A (231) is satisfied.

In one embodiment, the computing apparatus/system includes at each one of: the data warehouse (149), the transaction handler (103), the rule engine (209), the portal (143), the message broker (201), and the media controller (115), each of which may be implemented using a data processing system illustrated in FIG. 7, with more or less components.

For example, the data warehouse (149) includes at least one medium storage configured to: store data associating the plurality of accounts (401, 403, . . . , 407) of the user (101), and store offer rules (203) of the offer (186).

For example, the transaction handler (103) includes at least one processor (e.g., 173) configured to process payment transactions in payment accounts in a payment processing network, including: a first transaction in a first account (401) of the plurality of accounts (401, 403, . . . , 407) of the user (101), and a second transaction in a second account (403) of the plurality of accounts (401, 403, . . . , 407) of the user (101), where the second account (403) is separate and different from the first account (401).

For example, the rule engine (209) is coupled with the data warehouse (149) and the transaction handler (103) and configured to: determine the user satisfying a first requirement of the offer rules (203) of the offer (186) in response to the first transaction in the first account (401) of the plurality of accounts (401, 403, . . . , 407) of the user (101), and determine the user satisfying a second requirement of the offer rules (203) of the offer (186) based on: i) the second transaction in the second account (403) of the plurality of accounts (401, 403, . . . , 407) of the user (101), and ii) the user satisfying the first requirement via the first transaction in the first account (401) of the plurality of accounts (401, 403, . . . , 407) of the user (101).

For example, the offer rules (203) may be formulated based on events chained via prerequisite conditions, as illustrated in FIGS. 13-21; and the rule engine is further configured to generate and remove trigger records (207) in accordance with whether or not one or more the prerequisite conditions are satisfied by the user (101).

Some details about the system in one embodiment are provided in the sections entitled “CENTRALIZED DATA WAREHOUSE” and “HARDWARE.”

### Multiple Media Channels

In one embodiment, a computing apparatus is configured to store offers from various different sources and deliver the offers to users of consumer accounts through various media channels, such as websites, webpages delivered to mobile devices, applications running on mobile devices, digital wallet, email, social media, text messages, multimedia messages, etc. The computing apparatus is configured to deliver the offers to selected users based on qualification conditions specified for the respective offers. In one embodiment, the computing apparatus is further configured to apply the qualification conditions of the same offer differently based on the media channels through which the offer is to be delivered to the users.

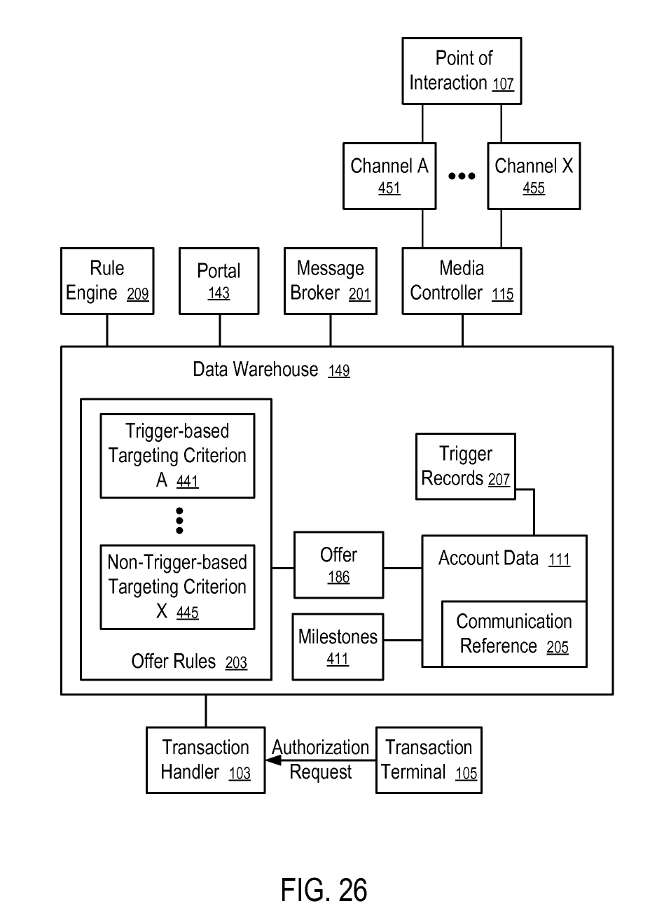

FIG. 26 shows a system to provide an offer to users via different media channels according to one embodiment. In FIG. 26, an offer (186) is delivery to a user (101) via a media channel (e.g., 451, . . . , or 455) when the user (101) satisfies the qualification conditions (e.g., 441, . . . , 445) of the offer (186) specified in the offer rules (203).

In one embodiment, the computing apparatus is configured to allow an offeror to specify two types of offer qualification conditions: trigger-based conditions (e.g., 441) and non-trigger-based conditions (e.g., 445).

Trigger-based conditions (e.g., 441) can be satisfied in response to current user actions at a time the offer is about to be delivery, such as the user (101) making a payment transaction using a consumer account (e.g., 146), the user (101) entering or leaving a predetermined geographic region as indicated by the current location of a mobile device of the user (101), etc. Trigger-based conditions (e.g., 441) cannot be satisfied in absence of current user actions that have one or more attributes satisfying the requirements specified in the trigger-based conditions (e.g., 441).

Non-trigger-based conditions (e.g., 445) are not based on the current user actions. For example, non-trigger-based conditions (e.g., 445) may be formulated based on the transaction profiles (e.g., 127, 131, 341) of the users (e.g., 101) that are generated based on the past transactions of the users (e.g., 101) in a predetermined period of time in the past, such as a year, six months, a month, etc. For example, non-trigger-based conditions (e.g., 445) may be formulated based on the information about spending patterns of the users (e.g., 101), demographic information about the users (e.g., 101), etc. Satisfying non-trigger-based conditions (e.g., 445) does not require the presence of a current user action that has one or more attributes satisfying the requirement of the non-trigger conditions (e.g., 445).

In one embodiment, the computing apparatus is configured to receive information about the current user actions in real time as the user actions occur and store trigger records (207) to determine whether the user actions satisfy the trigger-based conditions (e.g., 441) of the offers (e.g., 186). When a user action, such as a geographic presence at a location or a payment transaction, is detected and determined to satisfy the trigger-based conditions (e.g., 441) of an offer (186), and the user satisfies the non-trigger-based conditions (e.g., 445) of the offer (186), the offer (186) can be delivered, using one or more available media channels (e.g., 451, . . . , 455), to the user (101) in real time in response to the user action, if the offer (186) has not already been provided to the user (101) and associated with the account data (111) of the user (101) in the data warehouse (149).

In one embodiment, one or more media channels (e.g., 451, . . . , or 455) suitable for the real time delivery of the offer (186) is selected from available media channels (e.g., 451, . . . , 455) for the delivery of the offer (186). For example, in one embodiment, the selected media channel (e.g., 451) is associated with the communication reference (205) of the user (101); and the media controller (115) is configured to initiate the communication to provide the offer (186) to the user (101) in real time in response to the user action that satisfies the trigger-based conditions (e.g., 441) of the offer (186).

In one embodiment, the media channel (e.g., 451) selected to deliver the offer (186) in real time is separate from the media channel (e.g., 451) through which the respective user action is detected. For example, the transaction of the user (101) is detected via the receiving of the authorization request in the transaction handler (103) in one embodiment. For example, the geographic location of the user (101) is detected via the portal (143) in communication with a mobile application running in a mobile device of the user (101), or based on the authorization request from the transaction terminal (105) and the location information of the transaction terminal (105). The message containing the offer (186) may be provided using separate communication channels, such as short message service (SMS), email, instant message, voice message, push notification to mobile devices, etc.

In one embodiment, the media controller (115) is configured to use the media channel (e.g., 451), through which the user action is detected, to provide the offer (186), when the user action satisfies the trigger based conditions (e.g., 441) of the offer and the user (101) further satisfies the non-trigger based conditions.

In one embodiment, the rule engine (209) is configured to generate the trigger records (207) for users (101) who meet the requirements of the non-trigger-based qualification conditions (e.g., 445) and not generate trigger records for users who do not meet the non-trigger-based qualification conditions (e.g., 445). The rule engine (209) is configured to remove trigger records (207) for users who no longer satisfy the non-trigger-based qualification conditions (e.g., 445). Thus, the efficiency of the computing apparatus in identifying user actions that satisfy all requirements of the offer (186) is improved.

In one embodiment, the media channel (e.g., 451) selected to deliver the offer (186) in real time is selected for its capability to reach the user at a time selected by the computing apparatus; and the computing apparatus is configured to select the delivery time based on the detection of the user action that satisfies the trigger-based qualification conditions (e.g., 441).

In one embodiment, the computing apparatus is configured to ignore the trigger-based qualifications (e.g., 441) when certain media channels are available to deliver the offer (186) to the user (101). For example, when the user (101) is interacting with the portal (143), the media controller (115) is configured to provide the offer (186) to the user (101), if the user (101) satisfies the non-trigger-based qualification conditions (e.g., 445) but not the trigger-based qualification conditions (e.g., 441). For example, the media controller (115) may present the offer (186) to the user (101) when the user (101) is visiting a third party website, where the offer (186) is presented as a banner advertisement on the third party website.

In one embodiment, the data warehouse (149) is configured to store data associating the offer (186) to the account data (111) of the user (101) after the user (101) provides input indicating that the user (101) accepts the offer (186). For example, when the user (101) selects the offer (186) provided in the message transmitted to the user (101) using one of the available media channels (e.g., 451, . . . , 455), the user (101) is directed to the portal (143) to view the terms and conditions of the offers (186), an option selectable to accept the offer (186), and an option selectable to reject the offer (186).

In one embodiment, the media channels (e.g., 451, . . . , 455) include a first type of media channels that become available after the user (101) initiates the communication sessions or connections. If the user (101) does not take specific actions to initiate the communication sessions or connections, the media channels of the first type are not available for the media controller (115) to reach the user (101). For example, the media controller (115) cannot reach the user (101) via web or mobile application, if the user (101) does not take the action to visit a particular website, or launch the mobile application for interaction.

In one embodiment, when the media channels of the first type are available, the computing apparatus is configured to ignore the trigger-based qualification conditions (e.g., 441) and provide the offer (186) to the user (101) if the user (101) satisfies the non-trigger-based qualification conditions (e.g., 445).

In one embodiment, the media channels (e.g., 451, . . . , 455) include a second type of media channels that allows the media controller (115) to initiate a communicate with the user (101), without the user (101) having to initiate a communication session or connection. Thus, the media controller (115) is allowed to choose the timing for initiating the communication through the media channels of the second type. For example, the media controller (115) may transmit an email, a text message, a push notification, a post on social media, etc., without requiring the user (101) to provide input for establishing the communication session or connection prior to the communication initiated by the media controller (115). In one embodiment, the media controller (115) is configured to avoid providing the offer (186) via the media channels of the second type without satisfying the trigger-based qualification conditions (e.g., 441) of the offer (186). In one embodiment, when an offer does not have trigger-based qualification conditions, the media controller (115) does not provide such an offer via the media channels of the second type.

In one embodiment, when the offer (186) has a trigger-based qualification condition (e.g., 441) and non-trigger-based qualification conditions (e.g., 445), the rule engine (209) is configured to determine whether the user (101) satisfies the non-trigger-based qualification conditions (e.g., 445) of the offer (186). If the user (101) satisfies all the non-trigger-based qualification conditions (e.g., 445) of the offer (186), the rule engine (209) is configured to generate a trigger record (e.g., 207) to monitor user actions to detect actions that satisfy the trigger-based qualification condition (e.g., 441). If a user action satisfies the conditions associated the trigger record (e.g., 207), both the trigger-based qualification condition (e.g., 441) and the non-trigger-based qualification conditions (e.g., 445) are satisfied, and the media controller (115) is configured to provide the offer (186) to the user (101) via a media channel of the second type. If the user (101) does not satisfy all the non-trigger-based qualification conditions (e.g., 445) of the offer (186), the rule engine (209) does not generate a trigger record (e.g., 207) for the targeting of the offer (186) to the user (101); and thus, the rule engine does not need to monitor the user actions of the user (101) with respect to the trigger-based qualification condition (e.g., 441) of the offer (186).

In one embodiment, the account data (111) includes data identifying an account group (409) of the user (101); and the user (101) may use any account (e.g., 401, 403, . . . , 407) in the account group (409) to satisfy the trigger-based targeting criterion (e.g., 441) and/or the conditions in trigger records (207). More details and examples about associating an offer (186) with an account group (409) for automated benefit redemption are provided in the section entitled “MULTIPLE ACCOUNTS.”

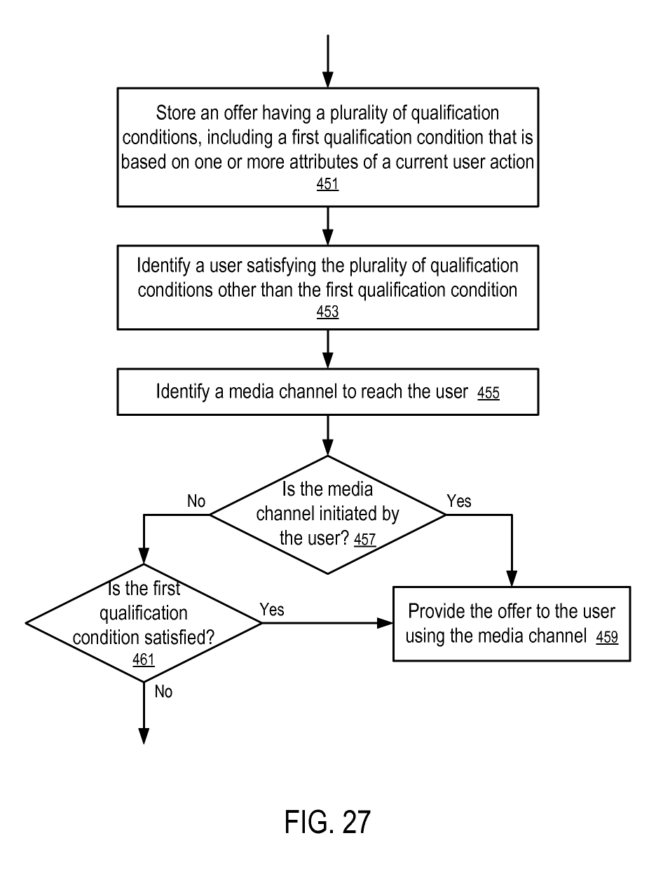

FIG. 27 shows a method to provide an offer to users through different media channels according to one embodiment. In FIG. 27, a computing apparatus is configured to: store (451) an offer (186) having a plurality of qualification conditions (e.g., 441, . . . , 445), including a first qualification condition (441) that is based on one or more attributes of a current user action at the time the offer (186) is about to be delivered to the user; identify (453) a user (101) satisfying the plurality of qualification conditions (e.g., 441, . . . , 445) other than the first qualification condition (441); identify (455) a media channel (e.g., 451, . . . , or 455) to reach the user; determine (457) whether the media channel (e.g., 451, . . . , or 455) is initiated by the user (101); and if so, provide (459) the offer (186) to the user (101) using the media channel (e.g., 451, . . . , or 455), regardless of whether the first qualification condition (441) is satisfied.

If it is determined (457) that the media channel (e.g., 451, . . . , or 455) is not initiated by the user (101), the computing apparatus is further configured to determine (461) whether the first qualification condition satisfied, and if so, the provide (459) the offer (186) to the user (101) using the media channel (e.g., 451, . . . , or 455). If it is determined (461) that the first qualification condition is not satisfied, the offer (186) is not provide to the user (101) at the current opportunity.

In one embodiment, the current opportunity is detected based on a user action, a predetermined time instant, or an event not related to the user (101), a request from an offeror, a request from a third party, etc.

In one embodiment, the determination of whether the first qualification condition is satisfied is based on matching attributes of current user actions and the requirements of trigger records (207).

In one embodiment, the method includes: storing, in the computing apparatus, data associating an offer (186) with at least one first criterion (e.g., 441) and at least one second criterion (e.g., 445), where the at least one first criterion is based on user locations or transactions, as illustrated in FIG. 26. The computing apparatus provides the offer (186) to the point of interaction (107) of the user (101) via a plurality of channels (e.g., 451, . . . , 455), when the user (101) satisfies the at least one second criterion (e.g., 445).

For example, when a first subset (e.g., 451) of the plurality of channels (e.g., 451, . . . , 455) is used to provide the offer (186), the offer (186) is provided in response to detection of the user locations or transactions satisfying the at least one first criterion (e.g., 441); and when a second subset (e.g., 445) of the plurality of channels (e.g., 451, . . . , 455) is used to provide the offer (186), the at least one first criterion (e.g., 441) is ignored.

For example, the method may further includes: generating, by the computing apparatus, a trigger record (e.g., 207) for the offer (186); and monitoring, by the computing apparatus based on the trigger record (207), transactions processed by a transaction handler (103) to identify transactions satisfying the at least one first criterion (e.g., 441).

For example, the first subset of the plurality of channels may include at least one of: email, social networking media, short message service, and multimedia message service; and the second subset of the plurality of channels may include at least one of: website, and mobile application.

For example, the at least one first criterion (e.g., 441) may be based on a particular transaction of the user (101), processed by the transaction handler (103) and satisfying a predetermined condition; and the offer (186) is provided through at least one channel (e.g., 451) in the first subset in real-time in response to authorization of the particular transaction of the user (101).

For example, the at least one first criterion (e.g., 441) may be based on a presence of the user (101) at a predetermined location; and the offer (186) is provided through at least one channel (e.g., 451) in the first subset in real-time in response to detection of the presence of the user (101) at the predetermined location.

A non-transitory computer-storage medium storing instructions configured to instruct the computing apparatus to at least: store offer rules (203) of the offer (186), including: one or more non-trigger-based criteria (e.g., 445), and one or more trigger-based criteria (e.g., 441) to be satisfied based on one or more attributes of a current event of the user (101), where the evaluation of whether the one or more trigger-based criteria (e.g., 441) are satisfied is to be triggered by the detection of the current event.

The instructions are further configured to instruct the computing apparatus to communicate the offer (186) to the user (101) via at least one of the plurality of media channels (e.g., 451, . . . , 455). For example, in response to a determination that the one or more trigger-based criteria and the one or more non-trigger-based criteria are satisfied by the user, the offer is transmitted to the user via a first media channel (e.g., 451); and in response to a determination that a second media channel (e.g., 455), different from the first medial channel (e.g., 451), is available to reach the user (101) and the one or more non-trigger-based criteria (e.g., 445) are satisfied by the user (101), the offer (186) is transmitted to the user (101) via the second media channel (e.g., 455) without requiring the one or more trigger-based criteria (e.g., 441) being satisfied.

For example, when the second media channel (e.g., 455) is established via a request from the user, the offer (186) can be transmitted to the user (101) via the second media channel (e.g., 455) without requiring the one or more trigger-based criteria (e.g., 441) being satisfied. For example, when transmission via the first media channel (e.g., 451) does not require a user action, the one or more trigger-based criteria (e.g., 441) is required to be satisfied to send the offer (186) to the user (101) via the first media channel (e.g., 451).

For example, the instructions can be further configured to instruct the computing apparatus to generate, after the one or more non-trigger-based criteria (e.g., 445) are satisfied by the user (101), one or more trigger records (e.g., 207) to detect events of the user related to the one or more trigger-based criteria (e.g., 441).

For example, the instructions can be further configured to instruct the computing apparatus to remove one or more trigger records (e.g., 207) to detect events of the user related to the one or more trigger-based criteria (e.g., 441), in response to a determination that the one or more non-trigger-based criteria (e.g., 445) are no longer satisfied by the user (101).

For example, the event may be a payment transaction of the user (101) processed by the transaction handler (103) of a payment processing network; and the instructions are further configured to instruct the computing apparatus to transmit a message containing the offer (186) to a communication reference (205) associated with a payment account (e.g., 146) of the user (101); and the message may be transmitted in response to an authorization response of the payment transaction in the payment account of the user.

For example, the event may be a location of a mobile device of the user (101) being detected to satisfy a predetermined requirement.

In one embodiment, the computing apparatus/system includes at each one of: the data warehouse (149), the transaction handler (103), the rule engine (209), the portal (143), the message broker (201), and the media controller (115), each of which may be implemented using a data processing system illustrated in FIG. 7, with more or less components.

For example, the data warehouse (149) has at least one computer storage device configured to store offer rules (203) of the offer (186), wherein the offer rules (203) include: one or more first criteria (e.g., 441) to be satisfied based on one or more attributes of a payment transaction of the user that causes evaluation of whether the one or more first criteria (e.g., 441) are satisfied, and one or more second criteria (445) satisfied by the user (101).

For example, the transaction handler (103) has at least one processor (e.g., 173) and configured to process payment transactions in a payment processing network and detect the payment transaction of the user (101) that satisfies the one or more first criteria (e.g., 441).

For example, the media controller (115) is coupled with the transaction handler (103) and configured to communicate the offer (186) to the user (101) via at least one of the plurality of media channels (e.g., 451, . . . , 455), including a first media channel (e.g., 451) and a second media channel (e.g., 455) different from the first media channel (e.g., 451). If the payment transaction of the user (101) satisfying the one or more first criteria (e.g., 441) is detected by the transaction handler (103), the media controller (115) is configured to initiate a communication with the user using the first communication channel (e.g., 451) to provide the offer (186); and if the second media channel (e.g., 455) initiated by the user (101) is available, the media controller (115) is configured to communicate the offer to the user (101) without requiring that the one or more first criteria (e.g., 441) be satisfied.

For example, the rule engine (209) is configured to generate one or more trigger records (e.g., 207) to detect the payment transaction processed by transaction handler (103); and the media controller (115) is configured to initiate the communication with the user (101) in real time with processing of authorization of the payment transaction.

For example, the one or more trigger records (e.g., 207) are generated in response to a first determination that the one or more second criteria (e.g., 441) are satisfied by the user (101); and the rule engine (209) is further configured to remove the one or more trigger records (207) in response to a second determination that the user (101) no longer satisfies the one or more second criteria (e.g., 445).

In one embodiment, the one or more first criteria (e.g., 441) cannot be satisfied in absence of the payment transaction that causes the evaluation of whether the one or more first criteria (e.g., 441) are satisfied.

In one embodiment, the offer (186) is communicated to the user (101) using the second media channel (e.g., 455) in response to a detection of the second media channel (e.g., 455).

### Multiple Merchants

In one embodiment, the portal (143) is configured to allow the specification of an offer campaign based on the requirements of transactions with multiple merchants. Thus, the offer campaign can be configured to be based on the transactions with multiple merchants, instead of a single merchant.

For example, in one embodiment, an offer campaign targeting NFL fans may involve multiple merchants. The campaign may be programmed via specifying a set of required events linked using prerequisite conditions, as illustrated in and discussed with FIGS. 11-22.

The set of requirement events involving different merchants in an offer campaign may be specified by a common representative that is authorized to act on behalf of the plurality of merchants.

Alternatively, or in combination with the use of a common representative, a collaborative portal (143) that be configured to allow collaboration among the merchants to define the offer campaign. The collaborative portal (143) allows each respective merchant in the set of merchants involved the offer campaign to specify events related to the respective merchant and identify prerequisite events that may or may not be associated with the respective merchant. Thus, the capability to add events specified by different merchants and the capability to link the added events to prerequisite events that may be specified by other merchants in the offer campaign allows the merchants to collaboratively generate a string or chain of events (e.g., 230, 233-235) that defines rules of the offer campaign, as if the offer campaign were specified by a single entity.

In one embodiment, the portal (143) is configured to allow the merchants to collaboratively specify a string or chain of events (e.g., 230, 233-235) for an offer campaign that is associated with transaction requirements of different merchants.

For example, the events (e.g., 230, 233-235) may correspond to payment transactions of users participating in the offer campaign to pay for purchases from respective different merchants that specify the respective events.

For example, a first merchant may specify in the offer campaign a first event that corresponds to a payment transaction for a purchase from the first merchant; and a second merchant may specify in the offer campaign a second event that corresponds to a payment transaction for a purchase from the second merchant. The second merchant may identify the first event as the prerequisite condition for the second event, and provide a benefit (e.g., discount, reward, statement credit, bash back) as a response to the second event. Since the first event is specified as a prerequisite condition of the second event, a user participating in the offer campaign is required to make a purchase from the first merchant according to the requirement of the first event and make a purchase from the second merchant according to the requirement of the second event to obtain the reward.

In one embodiment, the cost of the benefits provided to a user in the offer campaign is shared between or among the merchants involved in offer campaign, in accordance of a set of predetermined rules. For example, the cost may be evenly distributed between or among the merchants involved in offer campaign. For example, the cost may be divided between or among the merchants in proportional to the spending of the user, who participates in the offer campaign, with the respective merchants.

Alternatively, or in combination, each merchant may fund individual benefits independent from the benefits provided by other merchants in the offer campaign. For example, the first merchant in the example discussed above may specify a benefit to be provided to the user in response to the first event, in dependent of benefits provided by other merchants in the offer campaign; and the second merchant may specify a benefit to be provided to the user in response to the second event, independent of the benefit provided by the first merchant in response to the first event. Alternatively or in combination, the first merchant may, for example, specify a third event that requires the lapse of a predetermined amount of time from the second event that is specified as the prerequisite condition of the third event and provide a benefit to the user as a result of the third event for the user in the offer campaign.

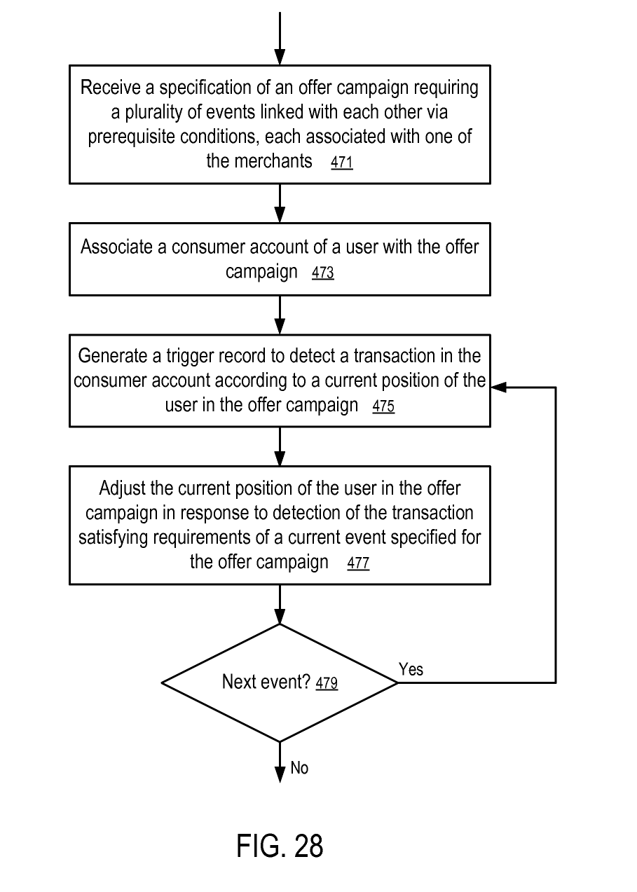

FIG. 28 shows a method to facilitate an offer campaign according to one embodiment. In FIG. 28, a computing device is configured to receive (471) a specification of an offer campaign requiring a plurality of events (230) linked with each other via prerequisite conditions (244), where each of the events (230) associated with one of the merchants.

In one embodiment, the portal (143) is configured to allow a set of merchants to register in a project to collaboratively create, modify and/or administrate the offer campaign. Alternatively or in combination, a representative of the portal (143) may create, modify and/or administrate the offer campaign on behalf of the participating merchants.

In one embodiment, the computing device is configured to: associate (473) a consumer payment account (146) of a user (101) with the offer campaign; generate (475) a trigger record (207) to detect a transaction in the consumer account (146) according to a current position of the user (101) in the offer campaign; and adjust (477) the current position of the user (101) in the offer campaign in response to detection of the transaction satisfying requirements of a current event (230) specified for the offer campaign.

In response to the detection of the transaction that satisfies the requirements of the current event (230) and that is detected via the current trigger record (207), the computing device performs an action specified in the current event (230), such as transmitting the message (247) to the user at the communication reference (205), and/or providing a benefit to the user (101).

In one embodiment, a benefit of the offer campaign is provided to the user (101) after the user (101) completes a plurality of events (e.g., 230) associated with different merchants in the offer campaign. For example, a benefit is provided to the user (101) as a statement credit to the consumer payment account (146) of the user (101) after the offer campaign reaches the end, or a final event of the offer campaign. The cost of the benefit can be shared among the respective merchants associated with the events (e.g., 230) that have been completed by the user (101) in accordance with the offer campaign. In some embodiments, the cost is shared among the merchants based on the transaction amounts (e.g., 304) of the respective transactions with the respective merchants in the offer campaign.

In one embodiment, each merchant can provide a separate reward for the completion of a transaction with the respective merchant. When a subsequent event requires the occurrence of one or more prior transaction events associated with one or more different merchants, as indicated by the prerequisite condition (244) of the subsequent event (230), the user (101) is required to perform a set of transactions with multiple merchants in the offer campaign to obtain the benefits associated with the subsequent event (230).

For example, in one embodiment of FIG. 13, the event (231) corresponds to a transaction with a first merchant; and the event (233) corresponds a transaction with a second merchant. Each of the first and second merchant may provide a reward in response to the corresponding transaction. As a result of the prerequisite condition link between the event (231) and the event (233), the user is required to transact with both merchant to obtain the reward from the second merchant in accordance with the event (233).

In one embodiment, the first and second merchants collectively provide a reward to the user after the user performs the event (235) that requires events (231 and 233) as prerequisite conditions.

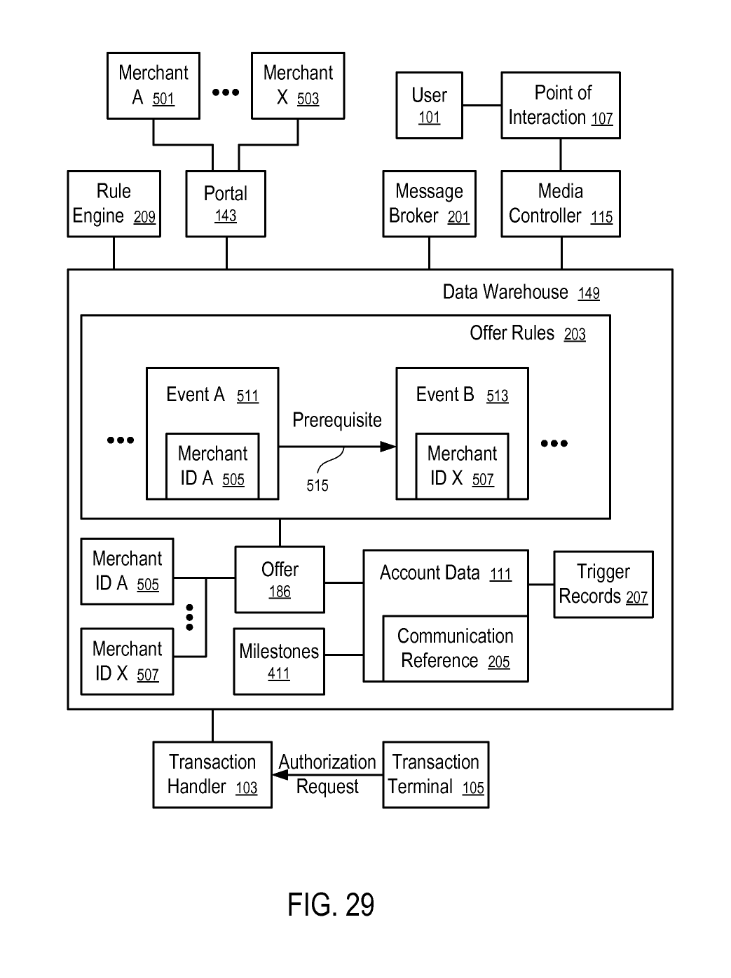

FIG. 29 shows a system to facilitate an offer campaign according to one embodiment. For example, the method of FIG. 28 can be implemented in the system of FIG. 29.

In FIG. 29, the rules (203) of the offer (186) are configured as events (e.g., 511, . . . , 513) linked with prerequisite conditions.

In FIG. 29, the data warehouse (149) is configured to associate the identification of a plurality of merchants with an offer (186). The association of the merchant IDs (e.g., 505, . . . , 507) with the offer (186) allows respective merchants (e.g., 501, . . . , 503), identified by the merchant IDs (e.g., 505, . . . , 507) respectively, to create and modify events (e.g., 511, . . . , 513) of the rules (203) of the offer (186) relevant to the respective merchants (e.g., 501, . . . , 503).

For example, in FIG. 29, the portal (143) is configured to provide a user interface that allows merchants (e.g., 501, . . . , 503), identified by the merchant IDs (e.g., 505, . . . , 507) respectively, to collaborative generate the offer rules (203) in a way as further discussed below.

When the merchant ID (505) of the merchant (501) is associated with the offer (186) in the data warehouse (149), the merchant (501) is provided by the portal (143) with access to specify an event (e.g., 511) that involves the merchant (501) as part of the rules (203) of the offer (186). For example, the merchant (501) may specify a transaction event that requires a transaction for a payment to the merchant (501) for a purchase from the merchant (501).

When the merchant (501) specifies the event (511) specific for the merchant (501) for the offer (186), the event (511) includes, or is associated with, the merchant ID (505) of the merchant (501); and the requirements to satisfy the event (511) are checked against activities involving the merchant (501) identified by the merchant ID (505). The merchant ID (505) included in, or associated with, the event (511) prevents other merchants from modifying the event (511).

In FIG. 29, since the event (511) is specific to the merchant (501) identified by the merchant ID (505), the merchant (501) is allowed to access a user interface of the portal (143) to adjust the event (511), such as editing the message (e.g., field (247) illustrated in FIG. 12) of the event (511), changing the prerequisite (e.g., field (247) illustrated in FIG. 12) of the event (511), etc.

Since the event (511) is specific to the merchant (501) identified by the merchant ID (505), other merchants (e.g., 503) involved in the offer (186) are not permitted to use the user interface of the portal (143) to adjust the event (511).

In one embodiment, a merchant or a representative of the portal (143) may specify an event that is not specific to any of the merchants (e.g., 501, . . . , 503) involved in the offer (186), such the event corresponds to the lapse of a predetermined time period from a previous event, a user enrolling for the offer (186), a user accessing a specific user interface of the portal (143), etc. When an event is not specific to any of the merchants (e.g., 501, . . . , 503) involved in the offer (186), each of the merchants (e.g., 501, . . . , 503) involved in the offer (186) is provided with access to modify the event.

By specifying events (e.g., 511, . . . , 513) for the rules (203) of the offer (186) and linking the events (e.g., 511, . . . , 513) via prerequisite conditions of the events (e.g., 511, . . . , 513), the merchants (501, . . . , 503) can used the portal (143) to collaboratively generate the offer rules (203) of the offer (186).

In FIG. 29, the rule engine (209) is configured to execute the campaign of the offer (186) in accordance with the offer rules (203).

For example, after the account data (111) of the user (101) is associated with the offer (186), the rule engine (209) is configured to track the milestones (411) of the user (101) in the offer (186). The milestones (411) identify the current position of the user (101) in the string/chain of events (e.g., 511, . . . , 513). The rule engine (209) is configured to generate the trigger records (207) to detect the next event (e.g., 513) of the user (101) based on the current position of the user (101) in the string/chain of events (e.g., 511, . . . , 513), and remove trigger records (207) are corresponding to the events that are before the current position of the user (101) and that are no longer relevant in the remaining life cycle of the campaign of the offer (186) for the user (101).

In FIG. 29, the message broker (201) is configured to generate messages in accordance with the specifications of the events (e.g., 511, . . . , 513); and the media controller (115) is configured to transmit the generated messages to the point of interaction (107) of the user (101) using the communication reference (205), in response to the respective events (e.g., 511, . . . , 513).

In one embodiment, at least some of the events (e.g., 511, . . . , 513) correspond to payment transactions processed by the transaction handler (103); and the events (e.g., 511, . . . , 513) are detected via the transaction handler (103) processing the authorization requests received in the payment processing network from the transaction terminals (e.g., 105) of the respective merchants (e.g., 501, . . . , 503).

Although FIG. 29 illustrates one transaction terminal (105), it is understood that the system generally includes multiple transaction terminal (105) of multiple merchants (e.g., 501, . . . , 503); and the payment processing network of the transaction handler (103) is connected to one or more issuer processors (e.g., 145) of consumer payment accounts (e.g., 146) and one or more acquirer processors (e.g., 147) of merchant accounts (e.g., 148).

In one embodiment, the system of FIG. 29 is configured to implement a method including: receiving, in a computing apparatus, a specification (e.g., offer rules (203)) of an offer campaign (e.g., offer (186)) of a plurality of merchants (e.g., 501, . . . , 503), where the offer campaign requires a plurality of events (e.g., 511, . . . , 513) linked with each other via prerequisite conditions (e.g., 515). Each event in the plurality of events (e.g., 511, . . . , 513) is associated with one merchant in the plurality of merchants (e.g., 501, . . . , 503); and the plurality of events (e.g., 511, . . . , 513) are associated with more than one merchant.

In one embodiment, the method further includes: associating, in the computing apparatus, a consumer payment account (e.g., 146 identified by account data (111)) of the user (101) with the campaign of the offer (186); and providing, by the computing apparatus, benefits of the offer campaign to the user (101) according to transactions in the consumer payment account (e.g., 146) and the specification of the offer campaign (e.g., offer rules (203)).

In one embodiment, the system of FIG. 29 is further configured to: track a current position of the user (101) in the offer campaign; generate a trigger record (207) to detect a transaction in the consumer payment account (146) according to a current event (e.g., 511) in the offer campaign corresponding to the current position of the user (101) in the campaign of the offer (186); and adjust the current position of the user (101) in the offer campaign in response to detection of the transaction satisfying requirements of the current event (e.g., 511).

In one embodiment, the system of FIG. 29 is configured to provide a benefit of the offer campaign to the user (101) on behalf one of the plurality of merchants (e.g., 501, . . . , 503), when the user (101) reaches a predetermined position in the offer campaign. The rule engine (209) is configured to track and execute of the campaign of the offer (186) for the user (101) in dependent of the progress of other users participating in the offer campaign.

In one embodiment, the system of FIG. 29 includes a portal (143) to receive the specification of the offer rules (149) from the plurality of merchants (e.g., 501, . . . , 503) for the campaign of the offer (186).

In one embodiment, the campaign of the offer (186) is pre-associated with the plurality of merchants (501, . . . , 503), identified by the merchant IDs (505, . . . , 507) respectively for associating with the offer (186) in the data warehouse (149); and the portal (143) is configured to provide each respective merchant (e.g., 501) associated with the campaign of the offer (186) with access to specify an event (e.g., 511) related to the respective merchant (e.g., 501).

In one embodiment, an event (e.g., 511) is specified as being related to a respective merchant (e.g., 501) identified by a corresponding merchant ID (e.g., 505); and the event (e.g., 511) requires a payment transaction between the respective merchant (e.g., 501) and a user participating in the offer campaign.

In one embodiment, the respective merchant (e.g., 501) is provided with the access to insert an event (e.g., 511) related to the respective merchant (e.g., 501) and/or provided the access to edit the event (e.g., 511) related to the respective merchant (e.g., 501).

In one embodiment, a respective merchant (e.g., 503) is provided with access to identify one or more events (e.g., 511), specified in the offer campaign but not associated with the respective merchant, as one or more prerequisite conditions of the event (e.g., 513) related to the respective merchant (e.g., 503). Thus, the events (e.g., 511, 513) associated with different merchants (e.g., 501, 503) can be linked via prerequisite condition (e.g., 515) in the offer (186).

For example, a respective merchant (e.g., 503) is provided with access to change one or more prerequisite conditions (e.g., 515) (corresponding to field (244) of event (230) in FIG. 12) of the event (e.g., 513) related to the respective merchant (e.g., 503); and the portal (143) prevents the respective merchant (e.g., 503) from adjusting events associated with those of the plurality of merchants (e.g., 501) that are not the respective merchant (e.g., 503).

In one embodiment, the plurality of events (e.g., 511, . . . , 513) include a first event (511) specified by a first merchant (501) and a second event (513) specified by a second merchant (503); and the first event (511) is a prerequisite condition of the second event (513) (e.g., as specified in the prerequisite field (244) of the second event (513)).

In one embodiment, the first event (511) is related to the first merchant (501) but not related to the second merchant (503); and the second event (513) is related to the second merchant (503) but not related to the first merchant (501).

In one embodiment, the first event (511) corresponds to a payment transaction with the first merchant (501); and the second event (513) corresponds to a payment transaction with the second merchant (503); and the first event (511) specifies a reward/benefit from the first merchant (501); and the second event (513) specifies a reward/benefit from the second merchant (503). Thus, a participant (e.g., user (101)) of the campaign of the offer (186) is required to make the payment transaction with the first merchant (501) according to the first event (511) to obtain the reward/benefit from the first merchant (501); and the participant (e.g., user (101)) is required to make the payment transaction with the first merchant (501) according to the first event (511) and the payment transaction with the second merchant (503) according to the second event (513) to obtain the reward/benefit from the second merchant (503).

In one embodiment, a computing apparatus of FIG. 28 is implemented using at least one data processing system illustrated in FIG. 7, including at least one microprocessor (173); and a memory (167) storing instructions configured to instruct the at least one microprocessor to perform operations.

The computing apparatus may include: a portal (143) configured to receive a specification (e.g., offer rules (203)) of an offer (186) of a plurality of merchants (e.g., 501, . . . , 503), which requires a plurality of events (e.g., 511, . . . , 513) linked with each other via prerequisite conditions (e.g., 515).

In one embodiment, each event in the plurality of events (e.g., 511, . . . , 513) is associated with one merchant in the plurality of merchants (501, . . . , 503); and the plurality of events (e.g., 511, . . . , 513) are associated with a plurality of merchants (e.g., 501, . . . , 503).

In one embodiment, the computing apparatus further includes: a data warehouse (149) configured to associate a consumer payment account (146) of a user (101) with the offer (186); and a transaction handler (103) coupled with the data warehouse (149) and configured to provide benefits of the offer (186) to the user (101) according to transactions in the consumer payment account (146) and the offer rules (203) specified by the merchants (501, . . . , 503) via the portal (143).

In one embodiment, the portal (143) is configured to provide a user interface allowing each respective merchant (e.g., 501) in the plurality of merchants (501, . . . , 503) pre-associated with the offer (186) to operate on (e.g., create, modify) the specification of one or more events (e.g., 511) related to the respective merchant (501) but not on specifications of events related to other merchants (e.g., 503).

In one embodiment, each event of the plurality of events (e.g., 511, . . . , 513) is associated with no more than one of the plurality of merchants.

Some details about the system in one embodiment are provided in the sections entitled “CENTRALIZED DATA WAREHOUSE” and “HARDWARE.”

### Variations

Some embodiments use more or fewer components than those illustrated in the figures.

In one embodiment, at least some of the profile generator (121), correlator (117), profile selector (129), and advertisement selector (133) are controlled by the entity that operates the transaction handler (103). In another embodiment, at least some of the profile generator (121), correlator (117), profile selector (129), and advertisement selector (133) are not controlled by the entity that operates the transaction handler (103).

In one embodiment, the products and/or services purchased by the user (101) are also identified by the information transmitted from the merchants or service providers. Thus, the transaction data (109) may include identification of the individual products and/or services, which allows the profile generator (121) to generate transaction profiles (127) with fine granularity or resolution. In one embodiment, the granularity or resolution may be at a level of distinct products and services that can be purchased (e.g., stock-keeping unit (SKU) level), or category or type of products or services, or vendor of products or services, etc.

In one embodiment, the entity operating the transaction handler (103) provides the intelligence information in real time as the request for the intelligence information occurs. In other embodiments, the entity operating the transaction handler (103) may provide the intelligence information in batch mode. The intelligence information can be delivered via online communications (e.g., via an application programming interface (API) on a website, or other information server), or via physical transportation of a computer readable media that stores the data representing the intelligence information.

In one embodiment, the intelligence information is communicated to various entities in the system in a way similar to, and/or in parallel with the information flow in the transaction system to move money. The transaction handler (103) routes the information in the same way it routes the currency involved in the transactions.

In one embodiment, the portal (143) provides a user interface to allow the user (101) to select items offered on different merchant websites and store the selected items in a wish list for comparison, reviewing, purchasing, tracking, etc. The information collected via the wish list can be used to improve the transaction profiles (127) and derive intelligence on the needs of the user (101); and targeted advertisements can be delivered to the user (101) via the wish list user interface provided by the portal (143). Examples of user interface systems to manage wish lists are provided in U.S. patent application Ser. No. 12/683,802, filed Jan. 7, 2010, assigned U.S. Pat. App. Pub. No. 2010/0174623, and entitled “System and Method for Managing Items of Interest Selected from Online Merchants,” the disclosure of which is hereby incorporated herein by reference.

### Aggregated Spending Profile

In one embodiment, the characteristics of transaction patterns of customers are profiled via clusters, factors, and/or categories of purchases. The transaction data (109) may include transaction records (301); and in one embodiment, an aggregated spending profile (341) is generated from the transaction records (301), in a way illustrated in FIG. 2, to summarize the spending behavior reflected in the transaction records (301).

In FIG. 2, each of the transaction records (301) is for a particular transaction processed by the transaction handler (103). Each of the transaction records (301) provides information about the particular transaction, such as the account number (302) of the consumer account (146) used to pay for the purchase, the date (303) (and/or time) of the transaction, the amount (304) of the transaction, the ID (305) of the merchant who receives the payment, the category (306) of the merchant, the channel (307) through which the purchase was made, etc. Examples of channels include online, offline in-store, via phone, etc. In one embodiment, the transaction records (301) may further include a field to identify a type of transaction, such as card-present, card-not-present, etc.

A “card-present” transaction typically involves physically presenting the account identification device (141), such as a financial transaction card, to the merchant (e.g., via swiping a credit card at a POS terminal of a merchant); and a “card-not-present” transaction typically involves presenting the account information (142) of the consumer account (146) to the merchant to identify the consumer account (146) without physically presenting the account identification device (141) to the merchant or the transaction terminal (105).

The transaction records (301) of one embodiment may further include details about the products and/or services involved in the purchase.

When there is voluminous data representing the transaction records (301), the spending patterns reflected in the transaction records (301) can be difficult to recognize by an ordinary person.

In FIG. 2, the voluminous transaction records (301) are summarized (335) into aggregated spending profiles (e.g., 341) to concisely present the statistical spending characteristics reflected in the transaction records (301). The aggregated spending profile (341) uses values derived from statistical analysis to present the statistical characteristics of transaction records (301) of an entity in a way easy to understand by an ordinary person.

In FIG. 2, the transaction records (301) are summarized (335) via factor analysis (327) to condense the variables (e.g., 313, 315) and via cluster analysis (329) to segregate entities by spending patterns.

In FIG. 2, a set of variables 311, 313, 315) are defined based on the parameters recorded in the transaction records (301). The variables 311, 313, and 315) are defined in a way to have meanings easily understood by an ordinary person. For example, variables (311) measure the aggregated spending in super categories; variables (313) measure the spending frequencies in various areas; and variables (315) measure the spending amounts in various areas. In one embodiment, each of the areas is identified by a merchant category (306) (e.g., as represented by a merchant category code (MCC), a North American Industry Classification System (NAICS) code, or a similarly standardized category code). In other embodiments, an area may be identified by a product category, a SKU number, etc.

Examples of the spending frequency variables (313) and spending amount variables (315) defined for various merchant categories (e.g., 306) in one embodiment are provided in U.S. patent application Ser. No. 12/537,566, filed Aug. 7, 2009, assigned U.S. Pat. App. Pub. No. 2010/0306029, and entitled “Cardholder Clusters,” and in U.S. patent application Ser. No. 12/777,173, filed May 10, 2010, assigned U.S. Pat. App. Pub. No. 2010/0306032, and entitled “Systems and Methods to Summarize Transaction Data,” the disclosures of which applications are hereby incorporated herein by reference.

In FIG. 2, the aggregation (317) includes the application of the definitions (309) for these variables 311, 313, and 315) to the transaction records (301) to generate the variable values (321). The transaction records (301) are aggregated to generate aggregated measurements (e.g., variable values (321)) that are not specific to a particular transaction, such as frequencies of purchases made with different merchants or different groups of merchants, the amounts spent with different merchants or different groups of merchants, and the number of unique purchases across different merchants or different groups of merchants, etc. The aggregation (317) can be performed for a particular time period and for entities at various levels.

The transaction records (301) can be aggregated according to a buying entity, or a selling entity. For example, the aggregation (317) can be performed at account level, person level, family level, company level, neighborhood level, city level, region level, etc. to analyze the spending patterns across various areas (e.g., sellers, products or services) for the respective aggregated buying entity. For example, the transaction records (301) for a particular merchant having transactions with multiple accounts can be aggregated for a merchant level analysis. For example, the transaction records (301) for a particular merchant group can be aggregated for a merchant group level analysis. The aggregation (317) can be formed separately for different types of transactions, such as transactions made online, offline, via phone, and/or “card-present” transactions vs. “card-not-present” transactions, which can be used to identify the spending pattern differences among different types of transactions.

In FIG. 2, the variable values (e.g., 323, 324, . . . , 325) associated with an entity ID (322) are considered the random samples of the respective variables 311, 313, 315), sampled for the instance of an entity represented by the entity ID (322). Statistical analyses (e.g., factor analysis (327) and cluster analysis (329)) are performed to identify the patterns and correlations in the random samples.

Once the cluster definitions (333) are obtained from the cluster analysis (329), the identity of the cluster (e.g., cluster ID (343)) that contains the entity ID (322) can be used to characterize spending behavior of the entity represented by the entity ID (322). The entities in the same cluster are considered to have similar spending behaviors.

In FIG. 2, the random variables (e.g., 313 and 315) as defined by the definitions (309) have certain degrees of correlation and are not independent from each other. For example, merchants of different merchant categories (e.g., 306) may have overlapping business, or have certain business relationships. For example, certain products and/or services of certain merchants have cause and effect relationships. For example, certain products and/or services of certain merchants are mutually exclusive to a certain degree (e.g., a purchase from one merchant may have a level of probability to exclude the user (101) from making a purchase from another merchant). Such relationships may be complex and difficult to quantify by merely inspecting the categories. Further, such relationships may shift over time as the economy changes.

In FIG. 2, a factor analysis (327) is performed to reduce the redundancy and/or correlation among the variables (e.g., 313, 315). The factor analysis (327) identifies the definitions (331) for factors, each of which represents a combination of the variables (e.g., 313, 315). A factor from the factor analysis (327) is a linear combination of a plurality of the aggregated measurements (e.g., variables (313, 315)) determined for various areas (e.g., merchants or merchant categories, products or product categories). Once the relationship between the factors and the aggregated measurements is determined via factor analysis, the values for the factors can be determined from the linear combinations of the aggregated measurements and be used in a transaction profile (127 or 341) to provide information on the behavior of the entity represented by the entity ID (e.g., an account, an individual, a family).

Once the factor definitions (331) are obtained from the factor analysis (327), the factor definitions (331) can be applied to the variable values (321) to determine factor values (344) for the aggregated spending profile (341). Since redundancy and correlation are reduced in the factors, the number of factors is typically much smaller than the number of the original variables (e.g., 313, 315). Thus, the factor values (344) represent the concise summary of the original variables (e.g., 313, 315).

For example, there may be thousands of variables on spending frequency and amount for different merchant categories; and the factor analysis (327) can reduce the factor number to less than one hundred (and even less than twenty). In one example, a twelve-factor solution is obtained, which allows the use of twelve factors to combine the thousands of the original variables (313, 315); and thus, the spending behavior in thousands of merchant categories can be summarized via twelve factor values (344). In one embodiment, each factor is combination of at least four variables; and a typical variable has contributions to more than one factor.

In FIG. 2, an aggregated spending profile (341) for an entity represented by an entity ID (e.g., 322) includes the cluster ID (343) and factor values (344) determined based on the cluster definitions (333) and the factor definitions (331). The aggregated spending profile (341) may further include other statistical parameters, such as diversity index (342), channel distribution (345), category distribution (346), zip code (347), etc., as further discussed below.

In general, an aggregated spending profile (341) may include more or fewer fields than those illustrated in FIG. 2. For example, in one embodiment, the aggregated spending profile (341) further includes an aggregated spending amount for a period of time (e.g., the past twelve months); in another embodiment, the aggregated spending profile (341) does not include the category distribution (346); and in a further embodiment, the aggregated spending profile (341) may include a set of distance measures to the centroids of the clusters.

FIG. 3 shows a method to generate an aggregated spending profile according to one embodiment. In FIG. 3, computation models are established (351) for variables 311, 313, and 315). In one embodiment, the variables are defined in a way to capture certain aspects of the spending statistics, such as frequency, amount, etc.

In FIG. 3, data from related accounts are combined (353); recurrent/installment transactions are combined (355); and account data are selected (357) according to a set of criteria related to activity, consistency, diversity, etc.

In FIG. 3, the computation models (e.g., as represented by the variable definitions (309)) are applied (359) to the remaining account data (e.g., transaction records (301)) to obtain data samples for the variables. The data points associated with the entities, other than those whose transactions fail to meet the minimum requirements for activity, consistency, diversity, etc., are used in factor analysis (327) and cluster analysis (329).

In FIG. 3, the data samples (e.g., variable values (321)) are used to perform (361) factor analysis (327) to identify factor solutions (e.g., factor definitions (331)). The factor solutions can be adjusted (363) to improve similarity in factor values of different sets of transaction data (109).

The data samples can also be used to perform (365) cluster analysis (329) to identify cluster solutions (e.g., cluster definitions (333)). The cluster solutions can be adjusted (367) to improve similarity in cluster identifications based on different sets of transaction data (109). For example, cluster definitions (333) can be applied to the transactions in the time period under analysis (e.g., the past twelve months) and be applied separately to the transactions in a prior time period (e.g., the twelve months before the past twelve months) to obtain two sets of cluster identifications for various entities. The cluster definitions (333) can be adjusted to improve the correlation between the two set of cluster identifications.

Optionally, human understandable characteristics of the factors and clusters are identified (369) to name the factors and clusters. For example, when the spending behavior of a cluster appears to be the behavior of an internet loyalist, the cluster can be named “internet loyalist” such that if a cardholder is found to be in the “internet loyalist” cluster, the spending preferences and patterns of the cardholder can be easily perceived.

In one embodiment, the factor analysis (327) and the cluster analysis (329) are performed periodically (e.g., once a year, or six months) to update the factor definitions (331) and the cluster definitions (333), which may change as the economy and the society change over time.

In FIG. 3, transaction data (109) are summarized (371) using the factor solutions and cluster solutions to generate the aggregated spending profile (341). The aggregated spending profile (341) can be updated more frequently than the factor solutions and cluster solutions, when the new transaction data (109) becomes available. For example, the aggregated spending profile (341) may be updated quarterly or monthly.

Details about aggregated spending profile (341) in one embodiment are provided in U.S. patent application Ser. No. 12/777,173, filed May 10, 2010, assigned U.S. Pat. App. Pub. No. 2010/0306032, and entitled “Systems and Methods to Summarize Transaction Data,” the disclosure of which is hereby incorporated herein by reference.

In one embodiment, a set of profiles are generated from the transaction data for a plurality of geographical regions, such as mutually exclusive, non-overlapping regions defined by postal codes. Transactions of account holders residing in the regions are aggregated according to merchant categories for the respective regions and subsequently normalized to obtain preference indicators that reveal the spending preferences of the account holders in the respective regions. Each of the profiles for respective regions is based on a plurality of different account holders and/or households to avoid revealing private information about individual account holders or families. Further, the profiles are constructed in a way to make it impossible to reverse calculate the transaction amounts. Further details and examples about profiles constructed for regions in one embodiment are provided in U.S. patent application Ser. No. 13/675,301, filed Nov. 13, 2012 and entitled “Systems and Methods to Summarize Transaction data,” the disclosure of which is hereby incorporated herein by reference.

### Transaction Processing and Data

FIG. 4 shows a system to provide information and/or services based on transaction data (109) according to one embodiment.

In FIG. 4, the transaction handler (103) is coupled between an issuer processor (145) and an acquirer processor (147) to facilitate authorization and settlement of transactions between a consumer account (146) and a merchant account (148). The transaction handler (103) records the transactions in the data warehouse (149). The portal (143) is coupled to the data warehouse (149) to provide information based on the transaction records (301), such as the transaction profiles (127), aggregated spending profile (341), offer redemption notification, etc. The portal (143) may be implemented as a web portal, a telephone gateway, a file/data server, etc.

In FIG. 4, the transaction terminal (105) initiates the transaction for a user (101) (e.g., a customer) for processing by a transaction handler (103). The transaction handler (103) processes the transaction and stores transaction data (109) about the transaction, in connection with account data (111), such as the account profile of an account of the user (101). The account data (111) may further include data about the user (101), collected from issuers or merchants, and/or other sources, such as social networks, credit bureaus, merchant provided information, address information, etc. In one embodiment, a transaction may be initiated by a server (e.g., based on a stored schedule for recurrent payments).

The accumulated transaction data (109) and the corresponding account data (111) are used to generate intelligence information about the purchase behavior, pattern, preference, tendency, frequency, trend, amount and/or propensity of the users (e.g., 101), as individuals or as a member of a group. The intelligence information can then be used to generate, identify and/or select targeted advertisements for presentation to the user (101) on the point of interaction (107), during a transaction, after a transaction, or when other opportunities arise.

In FIG. 4, the consumer account (146) is under the control of the issuer processor (145). The consumer account (146) may be owned by an individual, or an organization such as a business, a school, etc. The consumer account (146) may be a credit account, a debit account, or a stored value account. The issuer may provide the consumer (e.g., user (101)) an account identification device (141) to identify the consumer account (146) using the account information (142). The respective consumer of the account (146) can be called an account holder or a cardholder, even when the consumer is not physically issued a card, or the account identification device (141), in one embodiment. The issuer processor (145) is to charge the consumer account (146) to pay for purchases.

The account identification device (141) of one embodiment is a plastic card having a magnetic strip storing account information (142) identifying the consumer account (146) and/or the issuer processor (145). Alternatively, the account identification device (141) is a smartcard having an integrated circuit chip storing at least the account information (142). The account identification device (141) may optionally include a mobile phone having an integrated smartcard.

The account information (142) may be printed or embossed on the account identification device (141). The account information (142) may be printed as a bar code to allow the transaction terminal (105) to read the information via an optical scanner. The account information (142) may be stored in a memory of the account identification device (141) and configured to be read via wireless, contactless communications, such as near field communications via magnetic field coupling, infrared communications, or radio frequency communications. Alternatively, the transaction terminal (105) may require contact with the account identification device (141) to read the account information (142) (e.g., by reading the magnetic strip of a card with a magnetic strip reader).

The transaction terminal (105) is configured to transmit an authorization request message to the acquirer processor (147). The authorization request includes the account information (142), an amount of payment, and information about the merchant (e.g., an indication of the merchant account (148)). The acquirer processor (147) requests the transaction handler (103) to process the authorization request, based on the account information (142) received in the transaction terminal (105). The transaction handler (103) routes the authorization request to the issuer processor (145) and may process and respond to the authorization request when the issuer processor (145) is not available. The issuer processor (145) determines whether to authorize the transaction based at least in part on a balance of the consumer account (146).

The transaction handler (103), the issuer processor (145), and the acquirer processor (147) may each include a subsystem to identify the risk in the transaction and may reject the transaction based on the risk assessment.

The account identification device (141) may include security features to prevent unauthorized uses of the consumer account (146), such as a logo to show the authenticity of the account identification device (141), encryption to protect the account information (142), etc.

The transaction terminal (105) of one embodiment is configured to interact with the account identification device (141) to obtain the account information (142) that identifies the consumer account (146) and/or the issuer processor (145). The transaction terminal (105) communicates with the acquirer processor (147) that controls the merchant account (148) of a merchant. The transaction terminal (105) may communicate with the acquirer processor (147) via a data communication connection, such as a telephone connection, an Internet connection, etc. The acquirer processor (147) is to collect payments into the merchant account (148) on behalf of the merchant.

In one embodiment, the transaction terminal (105) is a POS terminal at a traditional, offline, “brick and mortar” retail store. In another embodiment, the transaction terminal (105) is an online server that receives account information (142) of the consumer account (146) from the user (101) through a web connection. In one embodiment, the user (101) may provide account information (142) through a telephone call, via verbal communications with a representative of the merchant; and the representative enters the account information (142) into the transaction terminal (105) to initiate the transaction.

In one embodiment, the account information (142) can be entered directly into the transaction terminal (105) to make payment from the consumer account (146), without having to physically present the account identification device (141). When a transaction is initiated without physically presenting an account identification device (141), the transaction is classified as a “card-not-present” (CNP) transaction.

In general, the issuer processor (145) may control more than one consumer account (146); the acquirer processor (147) may control more than one merchant account (148); and the transaction handler (103) is connected between a plurality of issuer processors (e.g., 145) and a plurality of acquirer processors (e.g., 147). An entity (e.g., bank) may operate both an issuer processor (145) and an acquirer processor (147).

In one embodiment, the transaction handler (103), the issuer processor (145), the acquirer processor (147), the transaction terminal (105), the portal (143), and other devices and/or services accessing the portal (143) are connected via communications networks, such as local area networks, cellular telecommunications networks, wireless wide area networks, wireless local area networks, an intranet, and Internet. Dedicated communication channels may be used between the transaction handler (103) and the issuer processor (145), between the transaction handler (103) and the acquirer processor (147), and/or between the portal (143) and the transaction handler (103).

In FIG. 4, the transaction handler (103) uses the data warehouse (149) to store the records about the transactions, such as the transaction records (301) or transaction data (109).

Typically, the transaction handler (103) is implemented using a powerful computer, or cluster of computers functioning as a unit, controlled by instructions stored on a computer readable medium. The transaction handler (103) is configured to support and deliver authorization services, exception file services, and clearing and settlement services. The transaction handler (103) has a subsystem to process authorization requests and another subsystem to perform clearing and settlement services. The transaction handler (103) is configured to process different types of transactions, such credit card transactions, debit card transactions, prepaid card transactions, and other types of commercial transactions. The transaction handler (103) interconnects the issuer processors (e.g., 145) and the acquirer processor (e.g., 147) to facilitate payment communications.

In FIG. 4, the transaction terminal (105) is configured to submit the authorized transactions to the acquirer processor (147) for settlement. The amount for the settlement may be different from the amount specified in the authorization request. The transaction handler (103) is coupled between the issuer processor (145) and the acquirer processor (147) to facilitate the clearing and settling of the transaction. Clearing includes the exchange of financial information between the issuer processor (145) and the acquirer processor (147); and settlement includes the exchange of funds.

In FIG. 4, the issuer processor (145) is configured to provide funds to make payments on behalf of the consumer account (146). The acquirer processor (147) is to receive the funds on behalf of the merchant account (148). The issuer processor (145) and the acquirer processor (147) communicate with the transaction handler (103) to coordinate the transfer of funds for the transaction. The funds can be transferred electronically.

The transaction terminal (105) may submit a transaction directly for settlement, without having to separately submit an authorization request.

In one embodiment, the portal (143) provides a user interface to allow the user (101) to organize the transactions in one or more consumer accounts (146) of the user with one or more issuers. The user (101) may organize the transactions using information and/or categories identified in the transaction records (301), such as merchant category (306), transaction date (303), amount (304), etc. Examples and techniques in one embodiment are provided in U.S. patent application Ser. No. 11/378,215, filed Mar. 16, 2006, assigned U.S. Pat. App. Pub. No. 2007/0055597, and entitled “Method and System for Manipulating Purchase Information,” the disclosure of which is hereby incorporated herein by reference.

In one embodiment, the portal (143) provides transaction based statistics, such as indicators for retail spending monitoring, indicators for merchant benchmarking, industry/market segmentation, indicators of spending patterns, etc. Further examples can be found in U.S. patent application Ser. No. 12/191,796, filed Aug. 14, 2008, assigned U.S. Pat. App. Pub. No. 2009/0048884, and entitled “Merchant Benchmarking Tool,” U.S. patent application Ser. No. 12/940,562, filed Nov. 5, 2010, and U.S. patent application Ser. No. 12/940,664, filed Nov. 5, 2010, the disclosures of which applications are hereby incorporated herein by reference.

### Transaction Terminal

FIG. 5 illustrates a transaction terminal according to one embodiment. The transaction terminal (105) illustrated in FIG. 5 can be used in various systems discussed in connection with other figures of the present disclosure. In FIG. 5, the transaction terminal (105) is configured to interact with an account identification device (141) to obtain account information (142) about the consumer account (146).

In one embodiment, the transaction terminal (105) includes a memory (167) coupled to the processor (151), which controls the operations of a reader (163), an input device (153), an output device (165) and a network interface (161). The memory (167) may store instructions for the processor (151) and/or data, such as an identification that is associated with the merchant account (148).

In one embodiment, the reader (163) includes a magnetic strip reader. In another embodiment, the reader (163) includes a contactless reader, such as a radio frequency identification (RFID) reader, a near field communications (NFC) device configured to read data via magnetic field coupling (in accordance with ISO standard 14443/NFC), a Bluetooth transceiver, a WiFi transceiver, an infrared transceiver, a laser scanner, etc.

In one embodiment, the input device (153) includes key buttons that can be used to enter the account information (142) directly into the transaction terminal (105) without the physical presence of the account identification device (141). The input device (153) can be configured to provide further information to initiate a transaction, such as a personal identification number (PIN), password, zip code, etc. that may be used to access the account identification device (141), or in combination with the account information (142) obtained from the account identification device (141).

In one embodiment, the output device (165) may include a display, a speaker, and/or a printer to present information, such as the result of an authorization request, a receipt for the transaction, an advertisement, etc.

In one embodiment, the network interface (161) is configured to communicate with the acquirer processor (147) via a telephone connection, an Internet connection, or a dedicated data communication channel.

In one embodiment, the instructions stored in the memory (167) are configured at least to cause the transaction terminal (105) to send an authorization request message to the acquirer processor (147) to initiate a transaction. The transaction terminal (105) may or may not send a separate request for the clearing and settling of the transaction. The instructions stored in the memory (167) are also configured to cause the transaction terminal (105) to perform other types of functions discussed in this description.

In one embodiment, a transaction terminal (105) may have fewer components than those illustrated in FIG. 5. For example, in one embodiment, the transaction terminal (105) is configured for “card-not-present” transactions; and the transaction terminal (105) does not have a reader (163).

In one embodiment, a transaction terminal (105) may have more components than those illustrated in FIG. 5. For example, in one embodiment, the transaction terminal (105) is an ATM machine, which includes components to dispense cash under certain conditions.

### Account Identification Device

FIG. 6 illustrates an account identifying device according to one embodiment. In FIG. 6, the account identification device (141) is configured to carry account information (142) that identifies the consumer account (146).

In one embodiment, the account identification device (141) includes a memory (167) coupled to the processor (151), which controls the operations of a communication device (159), an input device (153), an audio device (157) and a display device (155). The memory (167) may store instructions for the processor (151) and/or data, such as the account information (142) associated with the consumer account (146).

In one embodiment, the account information (142) includes an identifier identifying the issuer (and thus the issuer processor (145)) among a plurality of issuers, and an identifier identifying the consumer account among a plurality of consumer accounts controlled by the issuer processor (145). The account information (142) may include an expiration date of the account identification device (141), the name of the consumer holding the consumer account (146), and/or an identifier identifying the account identification device (141) among a plurality of account identification devices associated with the consumer account (146).

In one embodiment, the account information (142) may further include a loyalty program account number, accumulated rewards of the consumer in the loyalty program, an address of the consumer, a balance of the consumer account (146), transit information (e.g., a subway or train pass), access information (e.g., access badges), and/or consumer information (e.g., name, date of birth), etc.

In one embodiment, the memory includes a nonvolatile memory, such as magnetic strip, a memory chip, a flash memory, a Read Only Memory (ROM), etc. to store the account information (142).

In one embodiment, the information stored in the memory (167) of the account identification device (141) may also be in the form of data tracks that are traditionally associated with credits cards. Such tracks include Track 1 and Track 2. Track 1 (“International Air Transport Association”) stores more information than Track 2, and contains the cardholder's name as well as the account number and other discretionary data. Track 1 is sometimes used by airlines when securing reservations with a credit card. Track 2 (“American Banking Association”) is currently most commonly used and is read by ATMs and credit card checkers. The ABA (American Banking Association) designed the specifications of Track 1 and banks abide by it. It contains the cardholder's account number, encrypted PIN, and other discretionary data.

In one embodiment, the communication device (159) includes a semiconductor chip to implement a transceiver for communication with the reader (163) and an antenna to provide and/or receive wireless signals.

In one embodiment, the communication device (159) is configured to communicate with the reader (163). The communication device (159) may include a transmitter to transmit the account information (142) via wireless transmissions, such as radio frequency signals, magnetic coupling, or infrared, Bluetooth or WiFi signals, etc.

In one embodiment, the account identification device (141) is in the form of a mobile phone, personal digital assistant (PDA), etc. The input device (153) can be used to provide input to the processor (151) to control the operation of the account identification device (141); and the audio device (157) and the display device (155) may present status information and/or other information, such as advertisements or offers. The account identification device (141) may include further components that are not shown in FIG. 6, such as a cellular communications subsystem.

In one embodiment, the communication device (159) may access the account information (142) stored on the memory (167) without going through the processor (151).

In one embodiment, the account identification device (141) has fewer components than those illustrated in FIG. 6. For example, an account identification device (141) does not have the input device (153), the audio device (157) and the display device (155) in one embodiment; and in another embodiment, an account identification device (141) does not have components (151-159).

For example, in one embodiment, an account identification device (141) is in the form of a debit card, a credit card, a smartcard, or a consumer device that has optional features such as magnetic strips, or smartcards.

An example of an account identification device (141) is a magnetic strip attached to a plastic substrate in the form of a card. The magnetic strip is used as the memory (167) of the account identification device (141) to provide the account information (142). Consumer information, such as account number, expiration date, and consumer name may be printed or embossed on the card. A semiconductor chip implementing the memory (167) and the communication device (159) may also be embedded in the plastic card to provide account information (142) in one embodiment. In one embodiment, the account identification device (141) has the semiconductor chip but not the magnetic strip.

In one embodiment, the account identification device (141) is integrated with a security device, such as an access card, a radio frequency identification (RFID) tag, a security card, a transponder, etc.

In one embodiment, the account identification device (141) is a handheld and compact device. In one embodiment, the account identification device (141) has a size suitable to be placed in a wallet or pocket of the consumer.

Some examples of an account identification device (141) include a credit card, a debit card, a stored value device, a payment card, a gift card, a smartcard, a smart media card, a payroll card, a health care card, a wrist band, a keychain device, a supermarket discount card, a transponder, and a machine readable medium containing account information (142).

### Point of Interaction

In one embodiment, the point of interaction (107) is to provide an advertisement to the user (101), or to provide information derived from the transaction data (109) to the user (101).

In one embodiment, an advertisement is a marketing interaction which may include an announcement and/or an offer of a benefit, such as a discount, incentive, reward, coupon, gift, cash back, or opportunity (e.g., special ticket/admission). An advertisement may include an offer of a product or service, an announcement of a product or service, or a presentation of a brand of products or services, or a notice of events, facts, opinions, etc. The advertisements can be presented in text, graphics, audio, video, or animation, and as printed matter, web content, interactive media, etc. An advertisement may be presented in response to the presence of a financial transaction card, or in response to a financial transaction card being used to make a financial transaction, or in response to other user activities, such as browsing a web page, submitting a search request, communicating online, entering a wireless communication zone, etc. In one embodiment, the presentation of advertisements may be not a result of a user action.

In one embodiment, the point of interaction (107) can be one of various endpoints of the transaction network, such as point of sale (POS) terminals, automated teller machines (ATMs), electronic kiosks (or computer kiosks or interactive kiosks), self-assist checkout terminals, vending machines, gas pumps, websites of banks (e.g., issuer banks or acquirer banks of credit cards), bank statements (e.g., credit card statements), websites of the transaction handler (103), websites of merchants, checkout websites or web pages for online purchases, etc.

In one embodiment, the point of interaction (107) may be the same as the transaction terminal (105), such as a point of sale (POS) terminal, an automated teller machine (ATM), a mobile phone, a computer of the user for an online transaction, etc. In one embodiment, the point of interaction (107) may be co-located with, or near, the transaction terminal (105) (e.g., a video monitor or display, a digital sign), or produced by the transaction terminal (e.g., a receipt produced by the transaction terminal (105)). In one embodiment, the point of interaction (107) may be separate from and not co-located with the transaction terminal (105), such as a mobile phone, a personal digital assistant, a personal computer of the user, a voice mail box of the user, an email inbox of the user, a digital sign, etc.

For example, the advertisements can be presented on a portion of media for a transaction with the customer, which portion might otherwise be unused and thus referred to as a “white space” herein. A white space can be on a printed matter (e.g., a receipt printed for the transaction, or a printed credit card statement), on a video display (e.g., a display monitor of a POS terminal for a retail transaction, an ATM for cash withdrawal or money transfer, a personal computer of the customer for online purchases), or on an audio channel (e.g., an interactive voice response (IVR) system for a transaction over a telephonic device).

In one embodiment, the white space is part of a media channel available to present a message from the transaction handler (103) in connection with the processing of a transaction of the user (101). In one embodiment, the white space is in a media channel that is used to report information about a transaction of the user (101), such as an authorization status, a confirmation message, a verification message, a user interface to verify a password for the online use of the account information (142), a monthly statement, an alert or a report, or a web page provided by the portal (143) to access a loyalty program associated with the consumer account (146) or a registration program.

In other embodiments, the advertisements can also be presented via other media channels which may not involve a transaction processed by the transaction handler (103). For example, the advertisements can be presented on publications or announcements (e.g., newspapers, magazines, books, directories, radio broadcasts, television, digital signage, etc., which may be in an electronic form, or in a printed or painted form). The advertisements may be presented on paper, on websites, on billboards, on digital signs, or on audio portals.

In one embodiment, the transaction handler (103) purchases the rights to use the media channels from the owner or operators of the media channels and uses the media channels as advertisement spaces. For example, white spaces at a point of interaction (e.g., 107) with customers for transactions processed by the transaction handler (103) can be used to deliver advertisements relevant to the customers conducting the transactions; and the advertisement can be selected based at least in part on the intelligence information derived from the accumulated transaction data (109) and/or the context at the point of interaction (107) and/or the transaction terminal (105).

In general, a point of interaction (e.g., 107) may or may not be capable of receiving inputs from the customers, and may or may not co-located with a transaction terminal (e.g., 105) that initiates the transactions. The white spaces for presenting the advertisement on the point of interaction (107) may be on a portion of a geographical display space (e.g., on a screen), or on a temporal space (e.g., in an audio stream).

In one embodiment, the point of interaction (107) may be used to primarily to access services not provided by the transaction handler (103), such as services provided by a search engine, a social networking website, an online marketplace, a blog, a news site, a television program provider, a radio station, a satellite, a publisher, etc.

In one embodiment, a consumer device is used as the point of interaction (107), which may be a non-portable consumer device or a portable computing device. The consumer device is to provide media content to the user (101) and may receive input from the user (101).

Examples of non-portable consumer devices include a computer terminal, a television set, a personal computer, a set-top box, or the like. Examples of portable consumer devices include a portable computer, a cellular phone, a personal digital assistant (PDA), a pager, a security card, a wireless terminal, or the like. The consumer device may be implemented as a data processing system as illustrated in FIG. 7, with more or fewer components.

In one embodiment, the consumer device includes an account identification device (141). For example, a smart card used as an account identification device (141) is integrated with a mobile phone, or a personal digital assistant (PDA).

In one embodiment, the point of interaction (107) is integrated with a transaction terminal (105). For example, a self-service checkout terminal includes a touch pad to interact with the user (101); and an ATM machine includes a user interface subsystem to interact with the user (101).

### Hardware

In one embodiment, a computing apparatus is configured to include some of the components of systems illustrated in various figures, such as the transaction handler (103), the profile generator (121), the media controller (115), the portal (143), the profile selector (129), the advertisement selector (133), the user tracker (113), the correlator, and their associated storage devices, such as the data warehouse (149).

In one embodiment, at least some of the components such as the transaction handler (103), the transaction terminal (105), the point of interaction (107), the user tracker (113), the media controller (115), the correlator (117), the profile generator (121), the profile selector (129), the advertisement selector (133), the portal (143), the issuer processor (145), the acquirer processor (147), and the account identification device (141), can be implemented as a computer system, such as a data processing system (170) illustrated in FIG. 7. Some of the components may share hardware or be combined on a computer system. In one embodiment, a network of computers can be used to implement one or more of the components.

Further, the data illustrated in the figures, such as transaction data (109), account data (111), transaction profiles (127), and advertisement data (135), can be stored in storage devices of one or more computers accessible to the corresponding components. For example, the transaction data (109) can be stored in the data warehouse (149) that can be implemented as a data processing system illustrated in FIG. 7, with more or fewer components.

In one embodiment, the transaction handler (103) is a payment processing system, or a payment card processor, such as a card processor for credit cards, debit cards, etc.

FIG. 7 illustrates a data processing system according to one embodiment. While FIG. 7 illustrates various components of a computer system, it is not intended to represent any particular architecture or manner of interconnecting the components. One embodiment may use other systems that have fewer or more components than those shown in FIG. 7.

In FIG. 7, the data processing system (170) includes an inter-connect (171) (e.g., bus and system core logic), which interconnects a microprocessor(s) (173) and memory (167). The microprocessor (173) is coupled to cache memory (179) in the example of FIG. 7.

In one embodiment, the inter-connect (171) interconnects the microprocessor(s) (173) and the memory (167) together and also interconnects them to input/output (I/O) device(s) (175) via I/O controller(s) (177). I/O devices (175) may include a display device and/or peripheral devices, such as mice, keyboards, modems, network interfaces, printers, scanners, video cameras and other devices known in the art. In one embodiment, when the data processing system is a server system, some of the I/O devices (175), such as printers, scanners, mice, and/or keyboards, are optional.

In one embodiment, the inter-connect (171) includes one or more buses connected to one another through various bridges, controllers and/or adapters. In one embodiment the I/O controllers (177) include a USB (Universal Serial Bus) adapter for controlling USB peripherals, and/or an IEEE-1394 bus adapter for controlling IEEE-1394 peripherals.

In one embodiment, the memory (167) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

### Other Aspects

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

The disclosures of the above discussed patent documents are hereby incorporated herein by reference.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer-implemented method, comprising:
receiving, in a computing apparatus, a specification of an offer campaign of a plurality of merchants, the offer campaign requiring a plurality of events linked with each other via prerequisite conditions, each event in the plurality of events being associated with one merchant in the plurality of merchants, the plurality of events associated with more than one merchant;
associating, in the computing apparatus, a consumer payment account of a user with the offer campaign; and
providing, by the computing apparatus, benefits of the offer campaign to the user according to transactions in the consumer payment account and the specification of the offer campaign.

2. The method of claim 1, further comprising:
tracking a current position of the user in the offer campaign;
generating a trigger record to detect a transaction in the consumer payment account according to a current event in the offer campaign corresponding to the current position of the user in the offer campaign; and
adjusting the current position of the user in the offer campaign in response to detection of the transaction satisfying requirements of the current event.

3. The method of claim 2, further comprising:
providing a benefit of the offer campaign to the user on behalf one of the plurality of merchants, when the user reaches a predetermined position in the offer campaign.

4. The method of claim 1, further comprising:
providing a portal to receive the specification from the plurality of merchants for the offer campaign.

5. The method of claim 4, wherein the offer campaign is pre-associated with the plurality of merchants; and the portal is configured to provide each respective merchant associated with the offer campaign with access to specify an event related to the respective merchant.

6. The method of claim 5, wherein the event related to the respective merchant corresponds to a payment transaction between the respective merchant and a user participating in the offer campaign.

7. The method of claim 5, wherein the respective merchant is provided with access to insert an event related to the respective merchant.

8. The method of claim 7, wherein the respective merchant is provided with access to edit the event related to the respective merchant.

9. The method of claim 7, wherein the respective merchant is provided with access to identify one or more events specified in the offer campaign but not associated with the respective merchant as prerequisite conditions of the event related to the respective merchant.

10. The method of claim 7, wherein the respective merchant is provided with access to change one or more prerequisite conditions of the event related to the respective merchant.

11. The method of claim 8, wherein the portal prevents the respective merchant from adjusting events associated with the plurality of merchants other than the respective merchant.

12. The method of claim 1, wherein the plurality of events include a first event specified by a first merchant and a second event specified by a second merchant; and the first event is a prerequisite condition of the second event.

13. The method of claim 12, wherein the first event is related to the first merchant but not related to the second merchant; and the second event is related to the second merchant but not related to the first merchant.

14. The method of claim 13, wherein the first event corresponds to a payment transaction with the first merchant; and the second event corresponds to a payment transaction with the second merchant.

15. The method of claim 14, wherein the first event specifies a reward from the first merchant; and the second event specifies a reward from the second merchant.

16. The method of claim 15, wherein a participant of the offer campaign is required to make the payment transaction with the first merchant according to the first event to obtain the reward from the first merchant; and the participant of the offer campaign is required to make the payment transaction with the first merchant according to the first event and the payment transaction with the second merchant according to the second event to obtain the reward from the second merchant.

17. A non-transitory computer-storage medium storing instructions configured to instruct a computing apparatus to at least:
receive, in the computing apparatus, a specification of an offer campaign of a plurality of merchants, the offer campaign requiring a plurality of events linked with each other via prerequisite conditions, each event in the plurality of events being associated with one merchant in the plurality of merchants, the plurality of events associated with more than one merchant;
associate, in the computing apparatus, a consumer payment account of a user with the offer campaign; and
provide, by the computing apparatus, benefits of the offer campaign to the user according to transactions in the consumer payment account and the specification of the offer campaign.

18. A computing apparatus, comprising:
at least one microprocessor; and
a memory storing instructions configured to instruct the at least one microprocessor to perform operations, the computing apparatus comprising:
a portal configured to receive a specification of an offer campaign of a plurality of merchants, the offer campaign requiring a plurality of events linked with each other via prerequisite conditions, each event in the plurality of events being associated with one merchant in the plurality of merchants, the plurality of events associated with more than one merchant;
a data warehouse configured to associate a consumer payment account of a user with the offer campaign; and
a transaction handler coupled with the data warehouse and configured to provide benefits of the offer campaign to the user according to transactions in the consumer payment account and the specification of the offer campaign.

19. The computing apparatus of claim 18, wherein the portal is configured to provide a user interface allowing each respective merchant in the plurality of merchants pre-associated with the offer campaign to operate on specification of one or more events related to the respective merchant but not on specifications of events unrelated to the respective merchant.

20. The computing apparatus of claim 19, wherein each event of the plurality of events is associated with only one of the plurality of merchants.
